(19) United States
(12) Patent Application Publication
(10) Pub. No.: US 2004/0083954 A1
(43) Pub. Date: May 6, 2004

(54) Coating device

(76) Inventor: Takuji Nakamura, Hirakata-shi (JP)

Correspondence Address: CASELLA & HESPOS, 274 MADISON AVENUE, NEW YORK, NY, 10016

(21) Appl. No.: 10/433,372

(22) PCT Filed: Dec. 4, 2001
(86) PCT No.: PCT/JP01/10570

(30) Foreign Application Priority Data
May 12, 2000 (JP) 2000-370658
Feb. 22, 2001 (JP) 2001-46873
Mar. 1, 2001 (JP) 2001-56610

(51) Int. Cl. B05C 3/00; B05C 19/02

(52) U.S. Cl. 118/400; 118/429

(57) ABSTRACT

A coating apparatus having a fluid circulating system wherein the fluid ascending in a dipping container overflows an overflow edge disposed at the top of the dipping container into an overflow-fluid receiving container and returns from the bottom of the overflow-fluid receiving container into the dipping container, wherein the dipping container has a depth of ⅓ to ⅔ of the internal diameter thereof. When the dipping container is too deep, the powder or the like tends to be compressed tightly in the upper part of the dipping container, often impeding efficient insertion of a substrate, but the coating apparatus according to the present invention, the dimension thereof being specified as above, keeps favorable fluidity of the powder or the like.

### TECHNICAL FIELD

The present invention relates to a coating apparatus for applying on a substrate a powder or paste (slurry) for prevention of carburization and/or nitridation (hereinafter, referred to as “carburization/nitridation”). The powders, pastes, and the like suitable for use in the coating apparatus include not only those for prevention of carburization and nitridation, but also those for prevention of decarburization, denitridation, and oxidation. Hereinafter, the present invention will be described typically with reference to the powders for prevention of carburization and nitridation.

### BACKGROUND ART

Metal machine parts including cams, shafts, pistons, and pins commonly used in vehicles and vessels, or various gears and cutwares, demand a high toughness of the part as a whole and also a high level of wear resistance of the portion where a high frictional force is applied. Known as the method for producing these machine parts that are both excellent in toughness and wear resistance is a method to produce a machine part by using a high toughness steel as a raw material and subsequently to harden by carburization/nitridation only a portion thereof where a high wear resistance is required. In such a case, the portion of the machine part where the hardening is not required is typically masked and protected from the carburization/nitridation in order to keep the original toughness of the masked portion.

Paint-type masking agents that form a gas barrier film have been commonly known as this kind of masking agents. When the paint-type masking agent is used, the paint is first applied onto a particular portion of a steel product in advance of a heat treatment for carburization/nitridation, and the resulting coated steel product is heated at 300 to 1000° C. in a furnace containing a carburizing/nitriding agent or under an atmosphere of a carburizing/nitriding gas. Organic resins in the paint fade away by thermal decomposition under the heat, and at the same time, the ingredients therein for prevention of carburization/nitridation deposit on the surface of the steel product, forming a film for prevention of carburization/nitridation and blocking the contact of the coated portion with the carburizing/nitriding agent. In this way, the coated portion of the metal product is protected from carburization/nitridation.

It is extremely important to form a uniform defect-free anti-carburization/nitridation film, as the anti-carburization/nitridation film having surface unevenness or defects such as pinholes cannot accomplish the purpose of protecting the metal surface from the carburization/nitridation.

However, these paints are usually poor in fluidity and accordingly it is required to dilute the paint with a solvent and to coat the diluted paint several times for obtaining a uniform film. Such a coating method demands a sedulous work using a brush or the like and a large amount of manpower and labor. Hereinafter, this method of coating will be referred to as “the brushing method”.

Additionally, with respect to a substrate having curved and irregular surfaces, it is quite difficult to coat an anti-carburization/nitridation paint all over the irregular surface in a uniform thickness, inevitably leading to local defects in the protection from carburization/nitridation.

Alternatively, another method for protection from the carburization and nitridation by employing an anti-carburization/nitridation powder as the masking agent, which solved the problem described above, has been proposed (Japanese Unexamined Patent Publication No. 9-59757). The powders used in this protective method contain as the essential components an inorganic boron compound resistant to the carburization/nitridation agents and a thermofusing resin that decomposes under heat of the carburization or nitridation condition. Masking of a metal substrate is conducted in the following way. A portion of the metal substrate that should not to be carburized/nitrided (hereinafter, referred to as “the masking portion”) is heated and then an anti-carburization/nitridation powder is brought into contact with and fused and bonded on the masking portion (heated portion).

The methods for bringing the anti-carburization/nitridation powder into contact with the masking portion include, (1) a method to insert a masking portion of a metal substrate into an anti-carburization/nitridation powder contained in a container the top surface thereof being left open (hereinafter, referred to as “the insertion method”), (2) that to insert a masking portion of a metal substrate downward from above into an anti-carburization/nitridation powder moving in a fluidized state, maintained by placing the anti-carburization/nitridation powder on a screen that allows gas penetration (air and the like) and by blowing a gas at a certain speed upward from beneath the screen (hereinafter, referred to as “the fluidized bed method”), and (3) that to sprinkle an anti-carburization/nitridation powder from above over a masking portion of a metal substrate as it rotates (hereinafter, referred to as “the sprinkling method”). The method to sprinkle the powder typically employs a gutter or board on which the powder is placed and from which the powder is sprinkled by vibration thereof.

While it is practically impossible to establish a distinct borderline between the masking and non-masking portions by the fluidized bed or sprinkling method due to diffusion of the anti-carburization/nitridation powder, the insertion method has the advantage that it can establish the borderline distinctly. However, the method also has a problem in that it is difficult to mask the metal substrate at a particular position consistently, as a hole is formed in the powder whenever a substrate is inserted, perturbing the surface level of the powder for the next insertion.

Another coating apparatus by the insertion method that has solved this problem has been proposed in Japanese Unexamined Patent Publication No. 2000-212719. FIG. 31 is a perspective view of a coating apparatus 50; FIG. 32(a) is a schematic cross sectional view showing a method for using the coating apparatus 50; and FIG. 32(b) is a perspective view of a metal substrate coated with a powder.

The coating apparatus 50 is a double walled container (having an inner container 12 and an outer container 11), the two containers thereof being connected with two holes disposed close to the bottom, wherein the powder in inner container 12 is pushed upward (arrow C), forced to flow over an overflow edge 12a (arrow J) into an outer container 11, and fed back via connecting holes 16 disposed close to the bottom into an inner container 11 (arrow E and F). In this manner, the top surface of the powder in container 12 is always kept at a constant level. In the Figure, 17_{R} and 17_{L} represent screws for conveying the powder and the like; 19 represents an external motor for rotating these screws 17_{R} and 17_{L}; and 15 represents inclined guides for leading the overflowing powder and the like to connecting holes 16.

The use of the coating apparatus 50 enables masking of a metal substrate (substrate) 51 precisely at a predetermined position, as the top surface of the powder is kept at the same level even after the metal substrate is inserted and also establishing a distinct borderline between a masking portion 51a and a non-masking portion 51b.

### Disclosure of the Invention

However, in the coating apparatus shown in FIGS. 31 and 32, a fluid (powder and the like) in an inner container 12 could not be favorably pushed upward, often leading to, for example, compression of the powder and the like in the upper part of the inner container 12, thus resulting in prevention of favorable insertion of the substrate and generation of lumps of the powder and the like.

After an intensive study, the present inventors have found that the ratio of inner diameter to depth of the inner container 12 has a critical influence on the flow state of the powder in the inner container 12, and more specifically that the ratio of the inner diameter to depth of the inner container 12 shown in FIGS. 31 and 32 is about 1:1 and the powder and the like tend to be tightly packed in a container having such a ratio, as the container is too deep. The present invention is completed from the viewpoint that it is possible to move the powder and the like upward more effectively, by setting the ratio of inner diameter to depth of the inner container (dipping container) 12 in a suitable range.

Accordingly, a coating apparatus according to the present invention is a coating apparatus for coating a fluid such as a powder, a paste, or the like on a substrate, characterized in that the coating apparatus has a fluid circulation system, wherein the fluid ascending in a dipping container overflows an overflow edge at the top thereof into an overflow fluid receiving container and returns from the lower part of the receiving container back into the dipping container and the dipping container has a depth of 1/3 to 2/3 of the internal diameter thereof.

As described above, when the dipping container is too deep, it becomes increasingly difficult to keep fluidity of the fluid in the upper part of the dipping container and to make the fluid overflow smoothly the overflow edge of the dipping container due to formation of lumps, raising concerns that it might hinder insertion of the substrate into the fluid and provide an indefinite borderline between the masking and non-masking portions of the substrate. Alternatively, when the dipping container is too shallow, the top surface of the fluid is likely to undulate, making it more difficult to keep the surface of the fluid at a constant level.

In contrast, a dipping container having a depth of 1/3 to 2/3 of the internal diameter thereof enables to keep the fluidity of the fluid in the upper part of the dipping container at a favorable level by sending a fluid such as powder or the like upward efficiently, and allows the fluid to circulate smoothly between the dipping container (ascending region) and the overflow fluid receiving container (descending region). Consequently, it becomes possible to insert the substrate without difficulty into the fluid contained in the dipping container. Further, the top surface of the fluid thus being pushed upward and forced to overflow in this manner is not undulant and kept at a constant level, allowing establishment of a distinct borderline between masking and non-masking regions on the substrate.

The internal diameter above is an inner diameter of the dipping container when it is cylindrical, an average length of the major and minor axes thereof when it is an elliptic cylinder, a width of a side wall thereof when it is a square column, and an average length of the width and length thereof when it is a rectangular column.

The dipping container has preferably a depth of 40 to 60%, more preferably 45 to 55%, of the internal diameter thereof.

Additionally, in the present invention, both the dipping container and the overflow fluid-receiving container are preferably configured to be cylindrical in shape, and the dipping container is preferably disposed inside the overflow fluid-receiving container.

Although the fluid may be left stagnant at corners if the dipping container is, for example, a square column, the fluid can be circulated smoothly in the cylindrical container having no such stagnant places.

Additionally, in the present invention, a fluid having a repose angle of 50 degree or lower is preferably used as the fluid above.

A fluid with a repose angle of more than 50 degree is rather difficult to flow, making it difficult to circulate the fluid between the dipping and overflow fluid receiving containers. The lower limit of repose angle of the fluid is preferably 30 degree.

In addition, in the present invention, at least the dipping container is preferably configured to vibrate minutely.

The microvibration of the dipping container enables smoother overflow of a powder or the like (fluid) from the overflow edge. Additionally, the microvibration is also effective in keeping the top surface of the powder or the like contained in the dipping container accurately at the level of the overflow edge, allowing to determine a depth of the substrate inserted in the fluid without paying any consideration to undulation of the powder surface.

With respect to the microvibration of the dipping container, the amplitude is preferably 0.2 to 2.0 mm and the frequency is 2 to 33 Hz. More preferably, the amplitude is 0.8 mm or more and 1.2 mm or less, and the frequency is 17 Hz or more and 25 Hz or less.

Additionally, in the present invention, a screw for conveying a fluid from the lower part of the dipping container toward the overflow edge is preferred disposed in the dipping container.

Installation of the screw enables efficient upward migration and circulation of the fluid and such a fluid migration mechanism employing a screw can be installed rather cheaply.

Additionally, in the present invention, the dipping container preferably has a narrow discharge component having a narrow discharge opening disposed at the upper part of the cylindrical wall thereof, so that any desired surfaces of the substrate may be coated using the discharge opening as a fluid coating component for coating the fluid.

Although the masking method employing the coating apparatus described in above-described Japanese Unexamined Patent Publication No. 2000-212719, being a method to insert a substrate into a powder the top surface of which is kept at a constant height, is suitable for masking on an entire portion of a protrusion such as an end of a bar of a substrate 51 (masking portion 51a in FIG. 32(b)), the method could not be used, for example, when only a central portion of the bar of substrate is desirably masked (FIG. 30(a): a perspective view showing a bar of a metal substrate 52 having a masking portion at the central portion) and when only a part of a plate of a substrate is desirably masked (FIG. 30(b): a perspective view showing a plate of a metal substrate 53 having a masking portion at the central part of the plate). As shown in FIG. 30, for substrates having a masking portion 52a or 53 sandwiched by two or more non-masking portions 52b and 53b in an identical plane (at the same height), the coating means by insertion into a powder could not be used and should inevitably be replaced with the conventional brushing method.

In contrast, in the coating apparatus above having the narrow discharge opening, a fluid is forced to circulate between the dipping and overflow fluid receiving containers and to overflow the narrow discharge opening placed at the upper part of the dipping container by the fluid circulation system, and the top surface of the fluid overflowing the narrow discharge opening is confined to a small area slightly larger than that of the narrow discharge opening (in an amount of the powder overflowing the opening) and kept at a constant level. Therefore, it is possible to mask only a portion of the substrate which was brought into contact with the fluid, i.e., a portion matching the area of overflowing fluid, by bringing the substrate into close proximity of and further into contact with the top surface of the overflowing fluid. In this manner, the coating apparatus allows local masking on a non-protruding part of the substrate, and masking on portions in a variety of shapes and dimensions by modifying the dimension and shape of the narrow discharge opening according to the coating pattern of the substrate.

The dimension and shape of the narrow discharge opening may not necessarily be identical to the shape of the masking portion of the substrate. For example, in a coating apparatus employing a long and narrow opening suitable for the width of masking portion of the substrate, an entire masking length of the substrate may be coated by moving the substrate over the narrow discharge opening horizontally or rotationally.

Further, in the present invention, the narrow discharge component having a narrow discharge opening at the upper part thereof is preferably connected removably to the upper part of the cylinder wall described above.

By preparing a plurality of narrow discharge components different in dimension and shape of the narrow discharge opening and properly exchanging these narrow discharge components, it becomes possible for a coating apparatus to be compatible with a variety of masking shapes.

Further, in the present invention, the narrow discharge component having a narrow discharge opening is preferably disposed not directly connected to the cylinder wall.

In other words, the dipping container has preferably at least two overflow edges, i.e., an top edge of the cylinder wall (hereinafter, referred to as the “first overflow edge”) and a narrow discharge opening (hereinafter, referred to as the “second overflow edge”) disposed at the upper part of a narrow discharge component (e.g., an ascending fluid guide) placed at a position higher than the first overflow edge inside the dipping container.

In the case of a fluid such as a powder or paste, each particle or the like in the fluid, in contrast to a component in liquid wherein the component can migrate in any directions, only migrates upward when an upward force is applied. Therefore, the fluid overflows both the first and second overflow edges, even when there is a difference in height between these edges.

Further, in this invention too, a fluid such as a powder or the like keeps circulating between the dipping and overflow fluid receiving containers in the fluid circulation system and is always overflowing the first and second overflow edges. The top surface of the fluid overflowing this second overflow edge is confined to a small area slightly larger than that of the second overflow edge (in the amount of the powder overflowing the second overflow edge) and kept at a constant level. Therefore, as described above, it is possible to mask only a portion of the substrate which was brought into contact with the fluid, i.e., a portion matching the area of overflowing fluid, by bringing the substrate into close proximity of and further into contact with the top surface of the overflowing fluid. In this fashion, the coating apparatus allows local masking on a non-protruding part of the substrate and masking on a portion in a variety of shapes and dimensions by modifying the dimension and shape of the narrow discharge opening according to the coating pattern of the substrate.

The ascending fluid guide is, for example, cylindrical in shape and preferably straight and arranged in the direction of the ascending fluid. In contrast to the case where the guide is gradually narrowed toward a discharge opening as described above, there is almost no concern about the generation of lumps of powder and the like due to horizontal force applied when the guide is straight.

In this invention too, the dimension and shape of the second overflow edge may not necessarily be identical to the shape of the masking portion of the substrate. For example, in a coating apparatus employing the second overflow edge slightly smaller than the width of masking portion of a substrate, an entire masking portion of the substrate may be coated by moving the substrate over the second overflow edge horizontally or rotationally.

In addition, the ascending fluid guide is preferably configured to be removable.

By preparing a plurality of ascending fluid guides different in dimension and shape of the fluid overflow edge and by properly exchanging these ascending fluid guides, it becomes possible for a coating apparatus to be compatible with a variety of masking shapes.

Further in the present invention, the narrow discharge component is preferably physically supported by the overflow fluid-receiving container.

Additionally, in the present invention, the narrow discharge opening is preferably disposed at the top end of the narrow discharge component. In such a case, a coating fluid sticks out upward and overflows, making it easier to coat the substrate.

Further in the present invention, the narrow discharge opening is preferably an opening bored in the sidewall of the narrow discharge component. A substrate is brought into contact and coated with the fluid overflowing this opening.

Alternatively, in the present invention, the narrow discharge component preferably has an opening in the sidewall thereof and a gutter component connected the opening, wherein the top open part of the gutter component constitutes a narrow discharge opening. A fluid flows out of the opening into the gutter component and overflows the edge thereof. For coating, a substrate is brought into contact with the top surface of the fluid overflowing the gutter component.

With respect to the area of top surface of the fluid overflowing the gutter component, the width is slightly larger than that of the gutter component (in the amount of the powder overflowing), and the length is determined by the length and gradient angle of the gutter component. In this manner, a gutter component most suitable for the masking region of the substrate is desirably selected, by setting the dimension of the gutter component arbitrary.

Additionally, in the present invention, it is preferable to have a plurality of narrow discharge openings.

When there are a plurality of masking portions at intervals on a substrate, the use of the coating apparatus having a plurality of narrow discharge openings as described above enables simultaneous masking of a plurality of portions of the substrate.

When a plurality of the second overflow edges are present, two or more overflow edges may be disposed on an ascending fluid guide, or at least one second overflow edge may be disposed on two or more fluid ascending guides.

Additionally, in the present invention, the plurality of narrow discharge openings are preferably disposed in different heights.

When the masking portions are present on the surfaces of a substrate in different heights, the use of a coating apparatus having narrow discharge openings in heights corresponding to those of the masking portions enables simultaneous masking of these portions.

Additionally, in the present invention, the coating apparatus preferably has a conveying means for pushing further upward part of the fluid ascending in the dipping container and conveying it onto a particular outer surface of a substrate, which have a rotatable disk having a predetermined thickness, arranged in a direction so that the rotational axis thereof is completely or almost parallel to the top surface of a fluid contained in the dipping container, and at a position where part of the disk is inserted in the fluid at the upper part of the dipping container.

When an anti-carburization/nitridation powder is to be coated on an outer surface close to an end of a tubular substrate, the conventional insertion and fluidized bed methods wherein a tubular substrate is inserted into the powder from an edge thereof raise a problem that both the outer and inner surfaces of the tube become coated with the powder. In a similar manner, an end surface of a tubular substrate is always coated with the powder-by the insertion and fluidized bed methods, even when it is not desired.

In contrast, by the sprinkling method whereby a powder is poured onto the side surface of a tubular (or cylindrical) substrate, it is possible to coat the powder only on the side surface, without any powder attached to the inner surface of the tube (or, to the end surface of the cylinder). However, as the sprinkling method is a method whereby a powder is sprinkled from a gutter or plate by vibration thereof as described above, the area of the substrate on which the powder is sprinkled becomes larger, leading to spread of the powder to the portion of the substrate where masking is not desired.

However in a coating apparatus according to the present invention, a powder or the like in the dipping container is grabbed hold of and carried upward by the circumferential surface (side surface) of the rotating disk (e.g., gearwheel) and thrown onto a substrate placed in the opposite side of the rotating disk, for coating with the powder or the like.

As will be described below, the coating apparatus of the present invention enables more efficient coating of a powder on a substrate, compared to the case where a container having nothing other than an open upper end is employed as the container of the powder.

More specifically, when a container having only an open upper end is used, lumps of the powder are often generated by compression or voids containing no powder therein are formed over time in the container, resulting in an enlarged variation in the amount and width of the powder thrown by the disk and a problem of coating unevenness, i.e., that the powder is coated on the substrate with a greater variation in thickness and width. Additionally, the portion of the powder surface in the container where the powder is scooped up by the disk becomes concave, causing a problem of gradual decrease in the amount of the powder scooped up and thrown, which may finally lead to complete inability to coat the substrate.

However, in the present invention, as the powder or the like in the dipping container is always kept in a flowing state by the fluid circulation system, the powder or the like does not aggregate (does not form lumps) or form voids and is always present at the site of the inserted disk consistently in a certain flow state, enabling a stable coating of the powder or the like onto the substrate.

The amount of the powder transferred by the rotating disk may be modified according to the state (shape, smoothness, etc.) of circumferential surface of the disk and to the rotational velocity of the disk, and is preferably adjusted properly according to the desirable amount of the powder to be coated on the substrate. The method for coating a powder on a substrate by throwing the powder by a rotating disk in this way is advantageous in that the powder spreads on the substrate only narrowly in the width direction, compared to the sprinkling method described above and enables coating of the powder almost precisely in a predetermined width. The coating width on the substrate can be modified by changing the circumferential thickness (width) of the disk. Alternatively, in the coating apparatus having a relatively thin disk, the coating width may be adjusted by moving the substrate from side to side while the thin disk is throwing the powder narrowly. The conveying means according to the present invention include not only a configuration wherein a powder is grabbed hold of (scooped up) by the circumferential surface of a disk and thrown onto the substrate, but also a configuration wherein the powder grabbed by the circumferential surface of the disk is directly transferred to the surface of the substrate, by bringing the substrate into very close proximity of the disk circumferential surface.

As a powder or the like is always migrating upward in the dipping container in the fluid circulation system, the powder or the like is immediately supplied to the portion at the top of the dipping container where the powder or the like is scooped up (pushed upward) by the disk, leaving essentially no holes. As the ascending powder or the like is always overflowing the overflow edge, the top surface of the powder or the like is kept at a constant height, allowing the disk to be inserted at a constant depth therein and keeping the amount of the powder scooped up (pushed upward) by the disk at a constant value.

Further, at least the dipping container is preferably configured to vibrate minutely. While the fluid circulation system alone can almost prevent formation of holes as described above, additional microvibration of the dipping container makes the hole formation extremely difficult as it keeps the top surface of the powder in a still more uniform plain.

With simple microvibration of the dipping container alone, the powder or the like tends to become compressed and forms lumps, but the powder or the like in the coating apparatus of the present invention is consistently stirred by the circulation system as described above and thus prevented from compaction.

Additionally in the present invention, the disk is preferably a gearwheel. The powder is scooped up and conveyed by the gear portion (circumferential surface) of the gearwheel. The disks according to the present invention are not limited to gearwheels, but include disks having a rough and uneven circumferential surface.

Further, in the present invention, one or two guide plates for guiding the fluid are preferably disposed along one surface of the disk (one disk surface) or both surfaces of the disk (both disk surfaces).

When the powder is scooped up and thrown by the rotating disk, the powder flies to and scatters on a portion of a substrate slightly wider than that of the disk circumferential thickness, and the borderline between the coated and non-coated regions of the substrate tends to be slightly indefinite. However, installation of the above-described guide plates prevents such scattering of the powder and thus allows coating of the powder on a region having a predetermined coating width.

The guide plates may be configured in a direction parallel to the disk surface or slightly tapered.

Additionally, in the present invention, the coating apparatus is preferably a coating apparatus for coating a fluid on an outer surface of a substrate having an opening, wherein the coating apparatus has an opening-sealing means for sealing the opening; the opening sealing means has a sealing component for sealing the opening of the substrate placed at a position above the dipping container; and the substrate is inserted in the fluid while the sealing component is being pressed to the opening. That is, when the substrate is immersed in the fluid contained in the dipping container, the sealing component preferably seals the opening under pressure.

This invention is also suitable for coating, for example, of a tubular substrate having an opening (hole, slit) when only an outer surface thereof is desirably coated while the inner surface of the opening is being preventing from coating.

During the masking process, the substrate is inserted (dipped) into a fluid contained in the dipping container for coating with the fluid, when the sealing component fits and closes the opening of the substrate and is kept firmly connected to the opening under pressure while the substrate is being inserted in the fluid.

Thus, the fluid never enters inside the tubular substrate and only the outer side surface is coated with the fluid.

In the case of the sprinkling method, the powder often falls downward without being bonded even when it is brought into contact with the substrate. In other words, as the powder is not kept in contact with the substrate for a sufficient time, the amount of the powder that becomes fused thereon is limited even when a large amount of the powder is sprinkled. Accordingly, the substrate should be brought into contact with the sprinkling powder for a long period of time to assure a sufficiently amount of the powder fused onto the substrate, resulting in an elongated period of time for the masking operation. In the present invention above, as it is possible to keep a substrate inserted in the fluid for a certain period of time and to bring the powder or the like (fluid) into contact with the outer surface of the substrate for a sufficient period allowing the powder to fuse thereon, the coating apparatus does not demand such a long period of time as that required by the sprinkling method for the masking operation.

In addition, the fluid (powder or the like) keeps circulating between the dipping container (ascending region) and the overflow fluid receiving container (descending region) in the fluid circulation system and flowing consistently (not so vigorously that the powder does not have a sufficient time to contact with and fuse on the substrate, but mildly allowing contact and fusion of the powder), and the hole formed by insertion of the sealing component into the fluid contained in the dipping container can be immediately filled, seldom impeding the fluid coating on the substrate. As the fluid is always overflowing the overflow edge in the fluid circulation system, the top surface of the fluid is consistently kept at a constant level, allowing establishment of a distinct borderline between the masking and non-masking portions at a predetermined position.

A sealing component most suitable for the shape and dimension of the opening of the substrate is preferably selected as the sealing component. For example, when a spherical sealing component is used for sealing a tubular substrate, only the outer side surface close to an end and the end surface of the tubular substrate can be coated while the inner surface thereof is not coated with a fluid.

Alternatively, the coating apparatus of the present invention is preferably a coating apparatus having a covering means wherein the coating apparatus is equipped with a covering component for covering at least part of the substrate at a position above the dipping container and the substrate is inserted into the fluid while the covering component is being pressed to an end surface of the substrate. That is, when the substrate is immersed in the fluid contained in the dipping container, the covering component preferably covers at least part of the substrate inserted in the fluid under pressure. The substrates according to the present invention include those in various shapes, such as cylinders, square columns, and U and J shaped articles.

This invention is also suitable for coating of, for example, a substrate having an opening (hole, slit) when only an outer surface thereof is desirably coated while preventing the coating of the inner surface.

In a similar manner to the coating apparatus equipped with a sealing component, in the coating apparatus having the covering component too, the covering component is applied to at least part of the substrate (e.g., an end surface of a bar of substrate) so as to cover this portion (e.g., the end surface) and the substrate is inserted in the fluid while the covering component is being firmly pressed to the covering portion (the end surface). Thus, the covered portion of the substrate (the end surface) is not exposed to the fluid, allowing only the other inserted portion to be coated with the fluid.

In a similar manner to the embodiment above, as it is possible to keep the substrate inserted in the fluid for a certain period of time and to bring the powder or the like (fluid) into contact with an outer surface of a substrate for a sufficient period allowing the powder to fuse thereon, the coating apparatus according to the present invention does not demand a long period of time for the masking operation.

Further, in a similar manner to the embodiment above, as the fluid keeps circulating between the dipping container and the overflow fluid receiving container in the fluid circulation system and flowing consistently, a hole and the like formed by insertion of the covering component into the fluid can be immediately filled, seldom impeding the fluid coating on the substrate. In addition, as the fluid is always overflowing the overflow edge in the fluid circulation system, the top surface of the fluid is kept consistently at a constant level, allowing establishment of a distinct borderline between the masking and non-masking portions at a predetermined position.

A covering component most suitable for the shape and dimension of the non-masking portion of the substrate is preferably selected as the covering component of the present invention. For example, the covering components suitable for a bar of substrate include a component that covers part or all of an end surface of the bar, or that covering both the entire end surface and a part of the circumferential surface expanding therefrom. Alternatively, when the substrate is a U-shaped bar and the curved portion thereof is to be inserted into the fluid, a covering component in a shape covering the periphery of the curved portion is also included in the favorable covering components.

Further, in the present invention, the opening sealing or covering means preferably has a rod disposed above a fluid contained in the dipping container and in the direction almost parallel to the top surface of the fluid and the sealing or covering component attached to an end or at a position close to the end of the rod.

Suitable rods include bar springs and non-resilient metal rods. When a bar spring is employed, the opening sealing means (or covering means) is preferably configured to have the bar spring firmly connected to a base component at one end and to a sealing component (or covering component) at the other end. Alternatively, when a non-resilient metal rod is used, the opening sealing or covering means is preferably configured to have the rod connected to a weight at an end and supported by a supporting component at a position of rod slightly inward toward the other end, so that the other end of the bar (where a sealing or covering component is attached) can be lifted by the weight with respect to the supporting component.

As described above, an outer surface of a substrate can be coated, by advancing the substrate in the insertion direction allowing the sealing component to fit to and cap the opening (or allowing the covering component to cover part of the substrate) and subsequently by inserting the substrate in the fluid. During the insertion of the substrate, the edge of the bar of substrate (whereto the sealing or covering component is attached) is inserted together with the sealing component (or covering component) into the fluid (while, e.g., the bar spring is being bent or the weight at the tail portion of rod is being lifted), and the substrate, while the opening is being capped by the sealing component (or part of the substrate is being covered), is inserted deep into the fluid.

When a spring component is disposed inside the dipping container and used as the opening sealing or covering means as will be described below, the spring component may interfere with flow of the fluid ascending in the dipping container, depending on the structure and the arrangement of the spring component. However, if the “rod disposed above the fluid” is used, the rod and the sealing component (or covering component) do not affect the flow of the fluid in the dipping container at all when the substrate is not inserted into the fluid, eliminating a concern about the fluid forming lumps and the like.

Further, in the present invention, the opening sealing or covering means has preferably a sealing or covering component attached to the top end of the spring component disposed inside the dipping container.

An opening of the substrate is connected to and capped with the sealing component (or part of the substrate is connected to and covered with the covering component); the substrate is inserted into a fluid as the spring component is gradually compressed; and the outer side surface of the substrate is coated with the fluid.

During the insertion of the substrate deep into the fluid contained in the dipping container (ascending region), if a rod disposed in the direction almost parallel to the top surface of the fluid is used, the sealing component (or covering component) connected to the rod moves on a circular track while the substrate is inserted almost in the vertical direction, leading to a concern about generation of a gap at the sealed portion of the opening of substrate (or the covered portion of the substrate). However, when the spring component described above is used, there is no concern about generation of the gap as the substrate and the sealing component (or covering component) moves in the same direction.

Even when the rod disposed in the direction almost parallel as described above is used, there is no concern about generation of the gap if the substrate is not inserted so deeply.

Further in the present invention, the opening sealing or covering means has preferably two or more sealing or covering components.

In this embodiment are included (1) a coating apparatus equipped with a plurality of rods or spring components, each having a sealing component (or covering component), (2) a coating apparatus equipped with a rod or spring component having two or more sealing components (or covering components), and (3) a coating apparatus equipped with a plurality of rods or spring components, each having two or more sealing components (or covering components). Hereinafter, a set consisting of a rod (or spring component) and a sealing component (or covering component) is referred as at the “opening sealing unit”.

In the coating apparatus according to the above embodiments (1) and (3), the opening sealing units may be used simultaneously for masking operation, but it is more efficient to use each opening sealing unit sequentially for the masking operation and at the same time to clean (remove the attached powder or the like from) the other opening sealing units while not in use.

When two or more sealing components (or covering components) are present as described above, it is possible to mask two or more substrates at once, using two or more sealing components (or covering components) at the same time.

The coating apparatus according to the present invention also include a coating apparatus having two or more rods or spring components connected to a sealing component (or covering component).

### BRIEF DESCRIPTION OF THE DRAWINGS

FIG. 1 is a cross sectional view of a coating apparatus according to Embodiment 1 of the present invention (showing a bar of substrate inserted into a powder contained in the coating apparatus).

FIG. 2 is a perspective view of a coating apparatus according to Embodiment 2 of the present invention.

FIG. 3 is an exploded perspective view of the coating apparatus shown in FIG. 2.

FIG. 4 is a schematic cross sectional view showing the coating apparatus shown in FIG. 2 in use.

FIG. 5 is a perspective view showing a method of coating a powder locally onto a substrate using the coating apparatus according to Embodiment 2.

FIG. 6 is a perspective view showing another method of coating a powder locally using the coating apparatus according to Embodiment 2.

FIG. 7 is a perspective view showing yet another method of coating a powder locally using the coating apparatus according to Embodiment 2.

FIG. 8 is perspective and cross sectional views showing an overflow component of a coating apparatus according to Embodiment 3 of the present invention and a metal substrate.

FIG. 9 is a cross sectional view showing a method of coating using the coating apparatus according to Embodiment 3.

FIG. 10 is an illustration of a substrate coated by using the coating apparatus according to Embodiment 3.

FIG. 11 is a cross sectional view showing a method for further heating the masking portion of the metal substrate shown in FIG. 10.

FIG. 12 is a cross sectional view of an overflow component of a coating apparatus according to Embodiment 4 of the present invention, and a side view of a bar of metal substrate.

FIG. 13 is a perspective view showing a method of coating using the coating apparatus according to Embodiment 4.

FIG. 14 is a cross sectional view of an overflow component of a coating apparatus according to Embodiment 5 of the present invention and a side view of a bar of metal substrate.

FIG. 15 is a schematic cross sectional view showing a coating apparatus according to Embodiment 6 of the present invention in use.

FIG. 16 is a perspective view showing a method of coating a powder locally on a bar of metal substrate using the coating apparatus according to Embodiment 6.

FIGS. 17(a) and (b) are fragmentary perspective views of a coating apparatus according to Embodiment 7 of the present invention in use.

FIG. 18 is a fragmentary perspective view of a coating apparatus according to Embodiment 8 of the present invention in use.

FIG. 19 is a perspective view of a coating apparatus according to Embodiment 9 of the present invention.

FIG. 20 is a schematic vertical cross sectional view of the coating apparatus according to Embodiment 9 of the present invention.

FIG. 21 is a perspective view showing a masking method using the coating apparatus according to Embodiment 9 of the present invention.

FIG. 22 is a perspective view of a part of a coating apparatus according to Embodiment 10 of the present invention and a substrate.

FIG. 23 is a perspective view of a coating apparatus according to Embodiment 11 of the present invention and a substrate.

FIG. 24 is cross sectional views showing a masking method using the coating apparatus according to Embodiment 11.

FIG. 25 is a perspective view of a masked tubular substrate.

FIG. 26 is cross sectional views of a coating apparatus according to Embodiment 12 of the present invention and a tubular substrate.

FIG. 27 is a perspective view of a coating apparatus according to Embodiment 13 of the present invention and a tubular substrate.

FIG. 28 is a top surface view of a coating apparatus according to Embodiment 14 of the present invention.

FIG. 29 is cross sectional views of a coating apparatus according to Embodiment 15 of the present invention and a tubular substrate.

FIG. 30(a) is a perspective view of a bar of metal substrate 52 masked at the central portion, and

FIG. 30(b) is a perspective view of a plate of metal substrate masked at the central portion thereof.

FIG. 31 is a perspective view of a conventional coating apparatus.

FIG. 32(a) is a schematic cross sectional view showing a method of using the coating apparatus shown in FIG. 30, and

FIG. 32(b) is a perspective view of a metal substrate after coated with a powder.

### BEST MODE FOR CARRYING OUT THE INVENTION AND INDUSTRIAL APPLICABILITY

### Embodiment 1

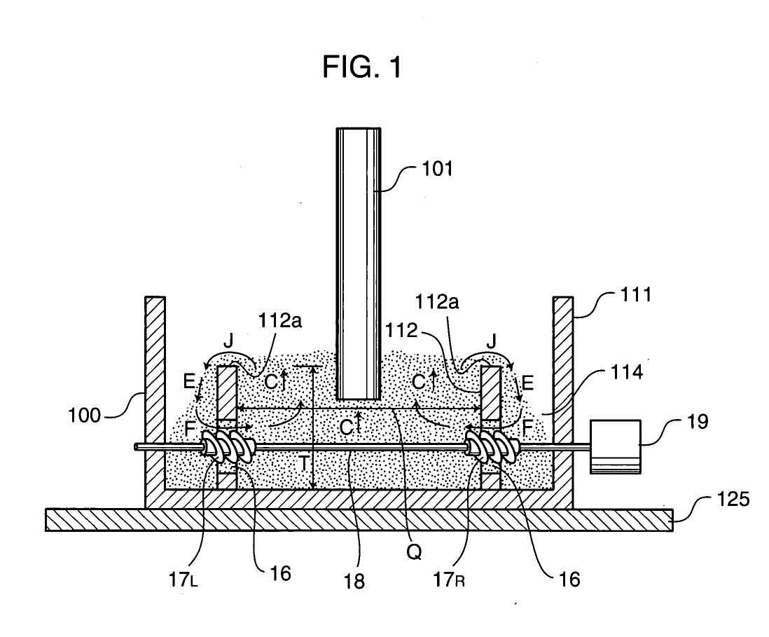

FIG. 1 is a cross sectional view of a coating apparatus 100 according to Embodiment 1 of the present invention, showing a bar of substrate 101 inserted into a powder (fluid) contained in the coating apparatus 100.

The coating apparatus 100 comprises a cylindrical outer container (overflow fluid receiving container) 111 and a cylindrical inner container (dipping container) 112 disposed inside the outer container 111; the top of both the outer container 111 and the inner container 112 is cut open; and the height of the inner container 112 is smaller than that of the outer container 111. The circular edge at the top wall of the inner container 112 represents an overflow edge 112a.

The inner container 112 has an internal diameter Q of 200 mm and a depth T of 100 mm. Thus, the depth is a half of the internal diameter.

Between the outer container 111 and the inner container 112, there is a gap 114, wherein multiple inclined guides are disposed (not shown in the Figure). In the lower sidewall close to the bottom of the inner container 112 are there two connecting holes 16 disposed at the opposite sides across the central axis of the inner container 112. Four inclined guides are disposed around the side wall from starting positions slightly lower than the overflow edge 112a to the connecting holes 16, so as to guide a powder (fluid) overflowing the overflow edge to connecting holes.

Two screws, 17_{R} and 17_{L} (fluid upward-migration mechanisms), are disposed on a rotational shaft 18 penetrating two connecting holes 16 at the position corresponding to respective holes 16. Screw 17_{R} has a right helical structure, while screw 17_{L} has a left helical structure. By the counterclockwise rotating of rotational shaft 18 by means of an external motor 19, both screws 17_{R} and 17_{L} exert a force to convey the powder (fluid) toward the central axis of the inner container 112.

The basal planes of the inner container 112 and the outer container 111 are connected to a microvibrator 125, and accordingly the inner container 112 and the outer container 111 vibrate by the bringing microvibrator 125 into operation.

Hereinafter, a method for bringing a powdery masking agent into contact with a metal substrate (substrate) 101 in the coating apparatus of Embodiment 1 will be described. The masking agent (powder) has a repose angle of about 39 to 44 degree.

The powder contained in the inner container 112 is driven upward as indicated by arrow C by the rotation of screws 17_{R} and 17_{L} and forced to flow over the overflow edge 112a into gap 114 (arrow J). The powder slides down along the inclined guides (arrow E) and reaches connecting holes 16. The powder is then conveyed from gap 14 into the inner container 112 (arrow F) by the rotation of screws 17_{R} and 17_{L} and pushed upward in the inner container 112. Again, the powder is driven upward as described above (arrow C) and forced to flow over the overflow edge 112a. The rotational frequency of screws 17_{R} and 17_{L} (diameter: 20 mm) is preferably 8 to 16 rpm, more preferably 9 to 12 rpm, but the rotational frequency may be modified arbitrarily according to the diameter of the screws.

In this manner, the powder keeps circulating by overflowing the inner container 112 into gap 14 in the outer container 111 and returning back into the inner container 112 via connecting holes 16.

As the inner container 112 has a ratio of internal diameter Q to depth T of 2 to 1, the powder in the inner container 112 is still soft and fluidal in the top part thereof and has a smooth non-undulating surface kept at a constant level. The powder is always kept homogeneous as it is consistently mixed by the circulation as described above.

An additional operation of the microvibrator 125, for example, vibration of the inner container 112 at an amplitude of about 1.0 mm and a frequency of twice/sec, enables very smooth circulation of the powder, allowing the top surface of the powder to be kept at a level exactly identical to the height of the overflow edge 112a.

A masking portion of a metal substrate 101 is then inserted into the powder flowing in the inner container 112 and brought into contact with the powder. As the masking portion is heated in advance, the powder fuses and bonds onto the masking portion by contact.

As described above, in the coating apparatus 100 according to Embodiment 1, the top surface of the powder is kept consistently at a level identical to the height of the overflow edge 112a and the powder is always kept in a soft state. Accordingly, the coating apparatus allows smooth insertion of the metal substrate 101 (substrate) and masking precisely at a predetermined position.

### Embodiment 2

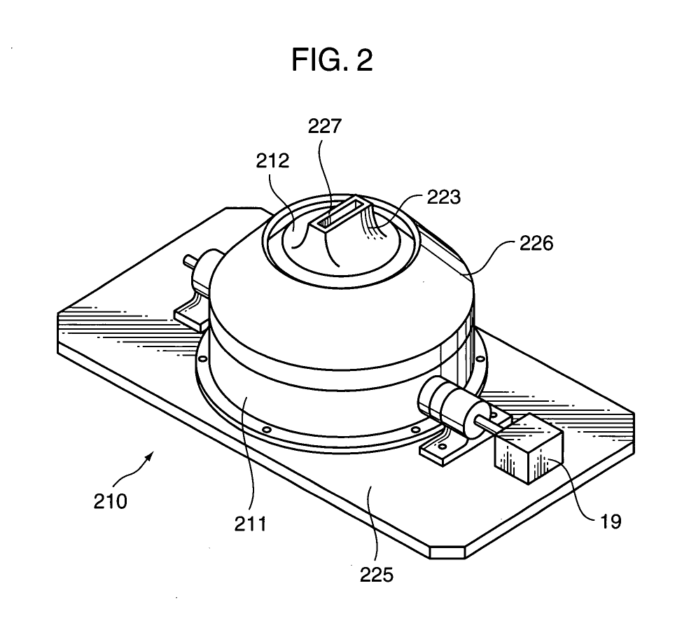

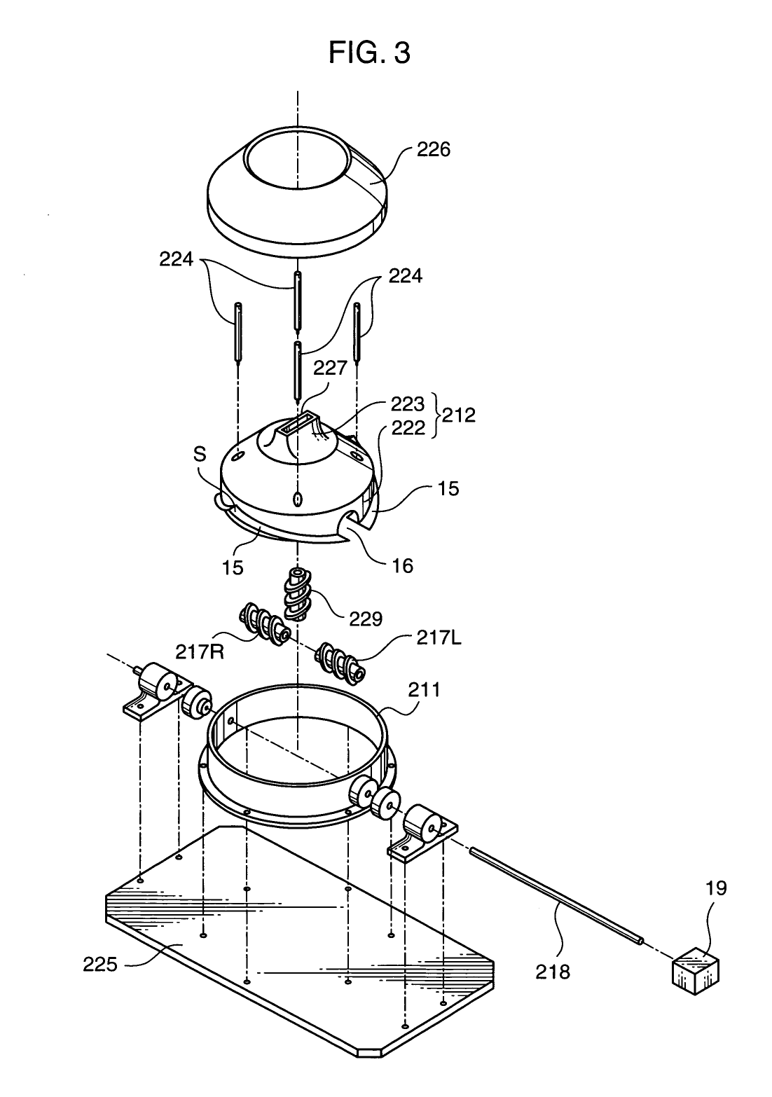

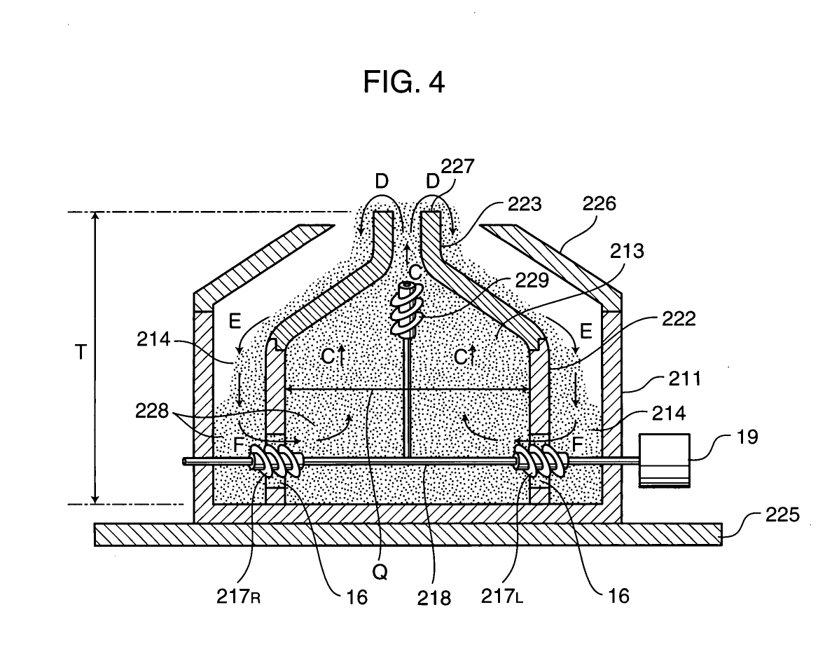

FIG. 2 is a perspective view of a coating apparatus 210 according to Embodiment 2 of the present invention; FIG. 3 is an exploded perspective view of the coating apparatus 210; and FIG. 4 is a schematic cross sectional view of the coating apparatus 210 in use.

The coating apparatus 210 comprises a cylindrical outer container (overflow fluid receiving container) 211 and a cylindrical inner container (dipping container) 212 disposed inside the outer container 211, wherein the portion inside the inner container 212 representing an ascending region 213 of a powder (fluid) and the gap between the outer wall of the inner container 212 and the inner wall of the outer container 211 representing a descending region 214. The outer container 211 is connected to a vibrator board 225, while the inner container 212 is connected to the outer container 211 with setscrews 224. Additionally, a dust control cover 226 is disposed atop the outer container 211, covering most of the space above the container.

The inner container 212 comprises an inner container wall (cylinder) 222, and a removable overflow component (narrow discharge component) 223 atop the inner container wall 222. Overflow component 223 is a roof-like component sticking out from the top of the inner container wall 222, becoming smaller in diameter with elevation in height, and has a tapered narrow discharge opening (narrow discharge opening) 227 atop the roof. Herein, the outer width of discharge opening 227 is slightly smaller than the dimension of the masking portion of the substrate.

The depth T of the inner container from the discharge opening 227 to the bottom of the inner container wall 222 is about half of internal diameter Q of the inner container wall 222.

At the lower part (close to the bottom) of the inner container wall 222, two connecting holes 16 are bored at positions opposite to each other with respect to the central axis of the inner container 212. Additionally, inclined guides 15 for guiding an overflowing powder from starting positions S to connecting holes 16 are disposed around the outer surface of the inner container wall 222.

In two connecting holes 16, two screws 217_{R} and 217_{L} are disposed on the same rotational shaft 218 penetrating connecting holes 16. The screw 217_{R} has a right helical structure, while screw 217ₗ has a left helical structure. By the counterclockwise rotating of the rotational shaft 18 by means of an external motor 19, both screws 217_{R} and 217_{L} exert a force to convey the powder (fluid) toward the central axis of the inner container 212.

In addition, a vertical screw 229 is disposed at the center of the inner container 212. The bottom end of the vertical screw 229 is connected via a gear (not shown in Figure) to the rotational shaft 218, and the vertical screw 229 rotates synchronously with the rotation of the rotational shaft 218. The rotation of this vertical screw 229 exerts a power to drive the powder upward to the discharge opening 227.

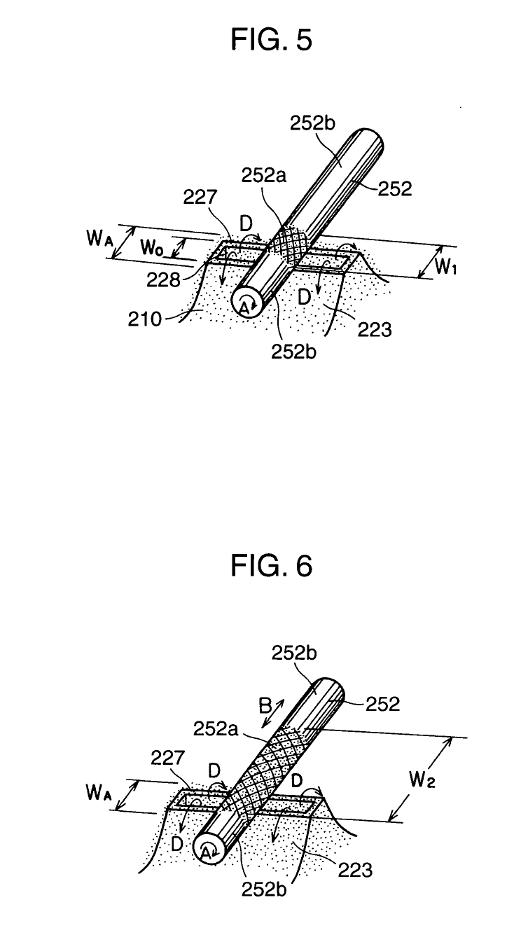

Hereinafter, a method for coating a powdery masking agent onto a metal substrate (substrate) in the coating apparatus of Embodiment 1 will be described. FIG. 5 is a perspective view of an overflow component 223 in the coating apparatus 210 and a metal substrate 252, showing a method for coating the powder 228 locally onto the metal substrate 252

As shown in FIG. 4, the powder 228 in the descending region 214 is conveyed via connecting holes 16 into the ascending region 213 (in the inner container 212) by the rotation of screws 217_{R} and 217_{L} (arrow F); as the powder 228 is steadily supplied via connecting holes 16, the powder 228 in the ascending region 213 is pushed upward (arrow C); and the rotation of the vertical screw 229 reinforces the upward migration of the powder (arrow C), allowing the powder 228 to overflow the discharge opening 227 (arrow D). Overflowing the powder 228 reaches the descending region 214 and slides down along the inclined guides 15 (arrow E) to the connecting holes 16. The powder is then conveyed again into the ascending region 213 (arrow F), pushed upward in the ascending region 213 (arrow C) and forced to flow over the discharge opening 227 (arrow D). In this manner, the powder 228 keeps circulating, by being forced to flow out of the ascending region 213 into the descending region 214 and conveyed back again into the ascending region 213 via the connecting holes 16 (in a “fluid circulation system”).

As the powder 228 keeps circulating as described above, the powder is always present on the discharge opening 227 overflowing the discharge opening 227 in a certain uniform shape without being scattered as in the case of the fluidized bed method described above. As the powder 228 is present in a protrusive state over the discharge opening 227 confined to a relatively small area of slightly larger than that formed by the outer edges of the discharge opening 227, it is possible to coat (mask) the powder locally on a specific region of the metal substrate (substrate) 252 with a definite dividing line between the masking and non-masking regions, by bringing the metal substrate into contact with the fluid 228 overflowing the discharge opening 227 (FIG. 5). It is preferable to heat a masking portion 252a in advance so as to allow the powder 228 to melt and bond in contact with the masking portion.

The width of the outer edges of the discharge opening 227 is preferably slightly smaller than the coating width of the metal substrate 252, so that the width of the overflowing powder becomes identical to the coating width of the metal substrate. In the example shown in FIG. 5, the overflow component 223 having an inner width W_{O} of the discharge opening 227 of slightly smaller than a coating width W₁ of the metal substrate 252 is used, so that the width W_{A} of overflowing the powder 228 is identical to W₁. In the same example, the bar of the metal substrate 252 is rotated around its axis (arrow A), allowing the surface of the bar to be circumferentially coated with the powder 228.

Additionally, micro-vibration of circulating the powder 228 in the ascending region 213 by bringing a vibrator board 225 into operation during the masking operation is effective for smoother overflowing of the powder 228 out of the discharge opening 227. In an analogous manner, the micro-vibration of the powder in the descending region 214 is also effective for smoother sliding down of the powder along the inclined guides 15.

FIG. 6 is a perspective view of an overflow component 223 of the coating apparatus 210 and a metal substrate 252, showing a method for coating a powder onto a relatively wide central portion of the bar of the metal substrate 252.

Although the coating width W₂ of the metal substrate 252 is much wider than the width W_{A} of overflowing the powder 228, it becomes possible to coat the powder 228 over the entire region of coating width W₂ by shifting the metal substrate 252 back and forth along its axis (in the direction of arrow B).

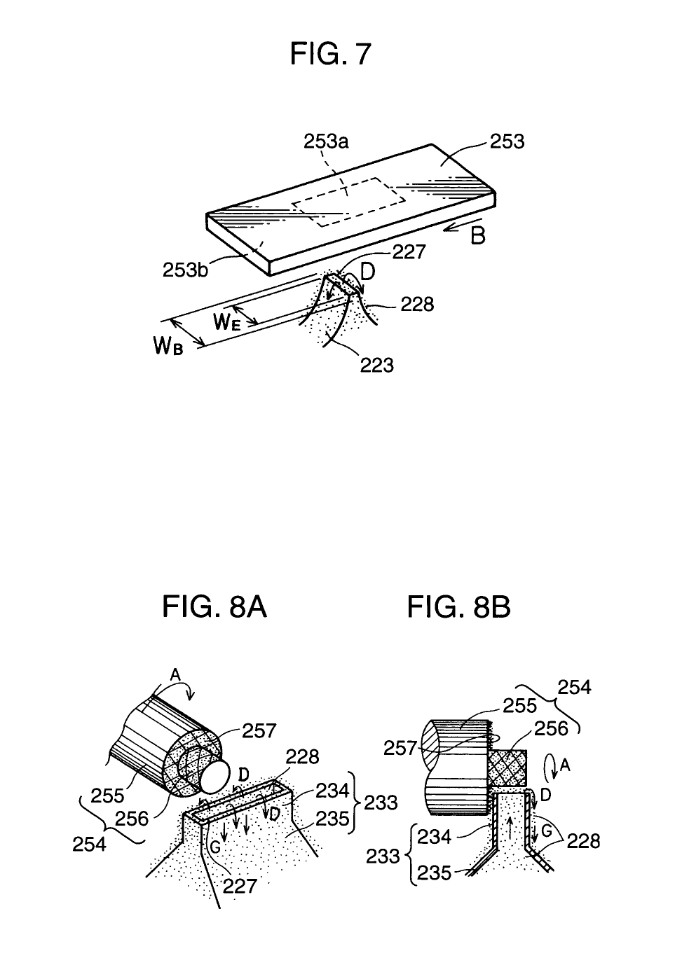

FIG. 7 is a perspective view of an overflow component 223 of the coating apparatus 210 and a metal substrate 253, showing a method for masking locally the central surface of the plate of the metal substrate 253.

By bringing masking portion 253a of the plate of the metal substrate 253 in contact with the powder 228 overflowing the discharge opening 227 and shifting the plate of the substrate 253 in the direction indicated by arrow B, it is possible to mask the central portion of the plate of the metal substrate 253 having a width W_{B} of the overflowing powder, slightly larger than the inner length W_{E} of the discharge opening 227.

As the powder 228 migrates upward along a pathway gradually tapered to narrow the discharge opening 227 and overflows the opening in Embodiment 2, the powder 228 may undesirably form clumps due to a horizontal force applied during the upward migration, resulting in difficulty in overflowing narrow the discharge opening 227. But in Embodiment 2, the presence of a screw 229 for conveying powder (fluid) 228 from the lower part of the ascending region 213 to narrow the discharge opening 227 allows smooth migration of the powder 228 to the discharge opening 227.

As described above, the fluid (powder and the like) is present on a predetermined confined area in a protrusive state in the coating apparatus according to Embodiment 2, and therefore it is possible to mask a particular portion of a substrate by bringing the substrate into contact with the protrusive fluid portion and accordingly to mask locally on a particular portion of the substrate with a definite dividing line between the masking and non-masking regions, even when the substrate does not have the masking portion in a protrusive state.

### Embodiment 3

Hereinafter, a coating apparatus according to Embodiment 3 of the present invention and a local coating method using the apparatus of the Embodiment 3 will be described. FIG. 8 shows an example of the local coating method; FIG. 8(a) is a perspective view of an overflow component 233 of the coating apparatus according to Embodiment 3 and a the metal substrate 254; and FIG. 8(b) is a cross sectional view of the overflow component 233 and a side view of the metal substrate 254.

While the overflow component 223 according to Embodiment 2 has an opening that is gradually tapered as the powder approaches to the discharge opening 227, an the overflow component 233 according to Embodiment 3 comprises a lower component 235 that is gradually tapered as the powder migrates upward and a vertical upper component 234, on the top of which is disposed a the discharge opening 227. The powder 228 overflowing the discharge opening 227 (arrow D) descends along the outer wall of upper component 234 of the overflow component 233 (arrow G). Alternatively, the overflow component 233 of this Embodiment 3 may be replaced with the above-described the overflow component 223 of the coating apparatus 210 of Embodiment 2.

The metal substrate 254 is a thick rod 255 having a rod 256 with a smaller diameter sticking out from the edge 257 thereof. The use of the overflow component 233 allows both the side surface of thin rod 256 and the edge surface 257 of the thick rod 255 to be brought into close proximity respectively of the discharge opening 227 and the outer wall of the upper component 234 and to be brought into contact with and masked with overflowing the powder 228.

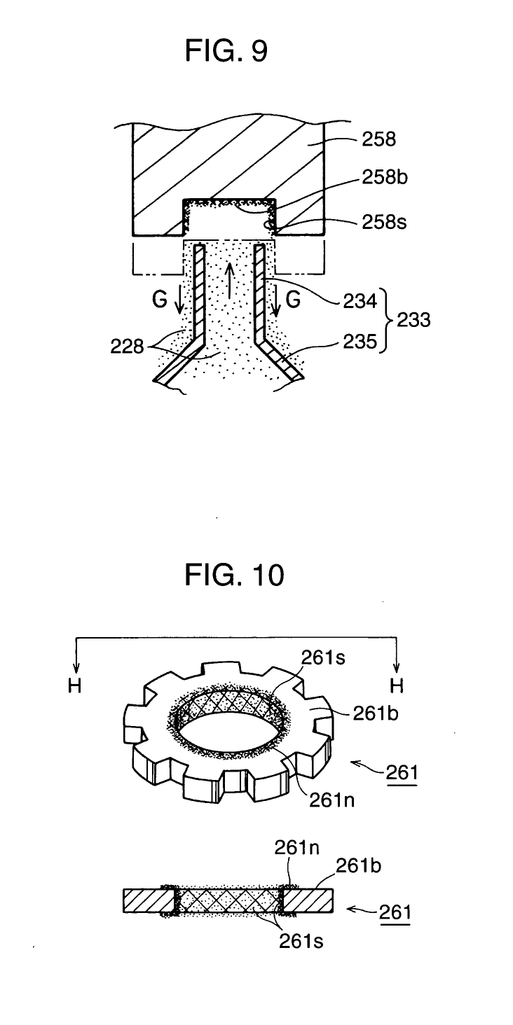

FIG. 9 is a cross sectional view showing a coating method using the coating apparatus according to Embodiment 3 and more specifically, a method for coating the powder 228 on the inner surface of a hole of a metal substrate 258.

By inserting the upper component 234 of the overflow component 233 into the hole of the metal substrate 258 (shown in FIG. 9 as a 2 dotted and dashed line), it becomes possible to coat both the inner bottom surface 258b and the inner side wall surface 258s of the hole with the powder 228.

FIG. 10 is an illustration showing another example of the coated substrate; FIG. 10(a) is a perspective view of a coated gear of the metal substrate 261; and FIG. 10(b) is a cross sectional view thereof along the H-H line.

It is possible to mask the inner empty wall 261s by bringing the metal substrate 261 in close proximity of the outer wall of the upper component 234 of the overflow component 233 and by bringing the inner empty wall 261s into contact with the powder 228, and to mask the surrounding of the hole, by bringing the surroundings of the hole 261n of the metal substrate 261 in close proximity of to the top of the discharge opening 227 of the overflow component and by bringing the surroundings of the hole 261n into contact with the powder 228. In the Figure, 261b indicates a non-masking portion, and as apparent from the Figure, the gear portion is not coated with the powder 228.

### Embodiment 4

FIG. 12 is a cross sectional view of an overflow component 243 in a coating apparatus according to Embodiment 4 of the present invention, and a side view of a bar of the metal substrate 259. In a similar manner to the above embodiment, the overflow component 243 according to Embodiment 4 may be replaced with the overflow component 223 of the coating apparatus 210 according to Embodiment 2.

The overflow component 243 of Embodiment 4 has two protrusions 244 and 245, and the protrusions 244 and 245 have narrow discharge openings 247 and 248 respectively.

A bar of the metal substrate 259 has two masking portions 259a at a certain interval. By placing two masking portions 259a respectively at positions of discharge openings 247 and 248 of the overflow component 243 and bringing the metal substrate 259 (arrow A) into contact with the powder 228 while the metal substrate is being rotated, it is possible to coat the powder 228 simultaneously on two different positions at a certain interval.

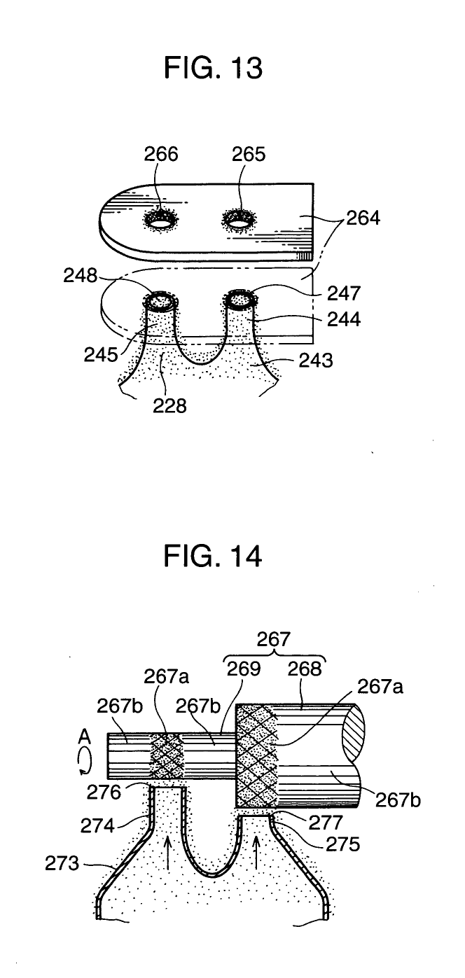

FIG. 13 is a perspective view showing another coating method using the coating apparatus according to Embodiment 4 and more specifically a method for coating with a powder inner walls 265 and 266 of two holes bored in a plate of the metal substrate 264. By bringing discharge openings 247 and 248 of the overflow component 243 in close proximity of the two holes in the metal substrate 264 respectively, inner walls 265 and 266 of the holes are coated with the powder 228.

### Embodiment 5

FIG. 14 is a cross sectional view of an overflow component 273 of a coating apparatus according to Embodiment 5 of the present invention and a side view of a bar of the metal substrate 267.

The overflow component 273 according to Embodiment 5 has two protrusions 274 and 275 different in height and these protrusions 274 and 275 have narrow discharge openings 276 and 277 respectively. In other words, the height of the overflow edge of narrow the discharge opening 276 is different from that of narrow the discharge opening 277, and thus the overflow component has two openings different in height.

The metal substrate 267 is a thick bar 268 having a thin bar 269 sticking out of the edge thereof, and has two masking portions 267a respectively on the thick bar 268 and the thin bar 269 at a certain interval. It is possible to mask simultaneously the two masking regions different in height, by bringing the masking portions 267a respectively in close proximity of the discharge openings 276 and 277 of the overflow component 273 and bringing the same portions in contact with the powder 228.

### Embodiment 6

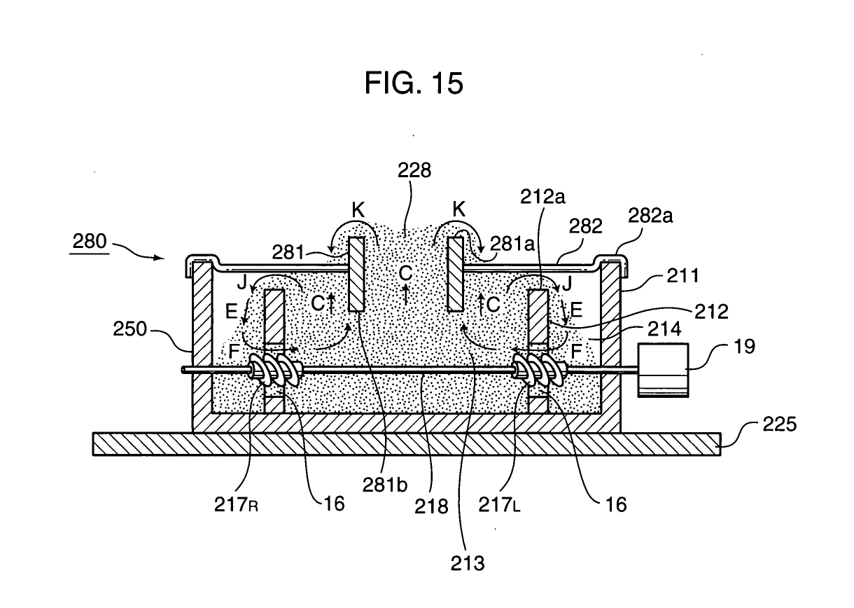

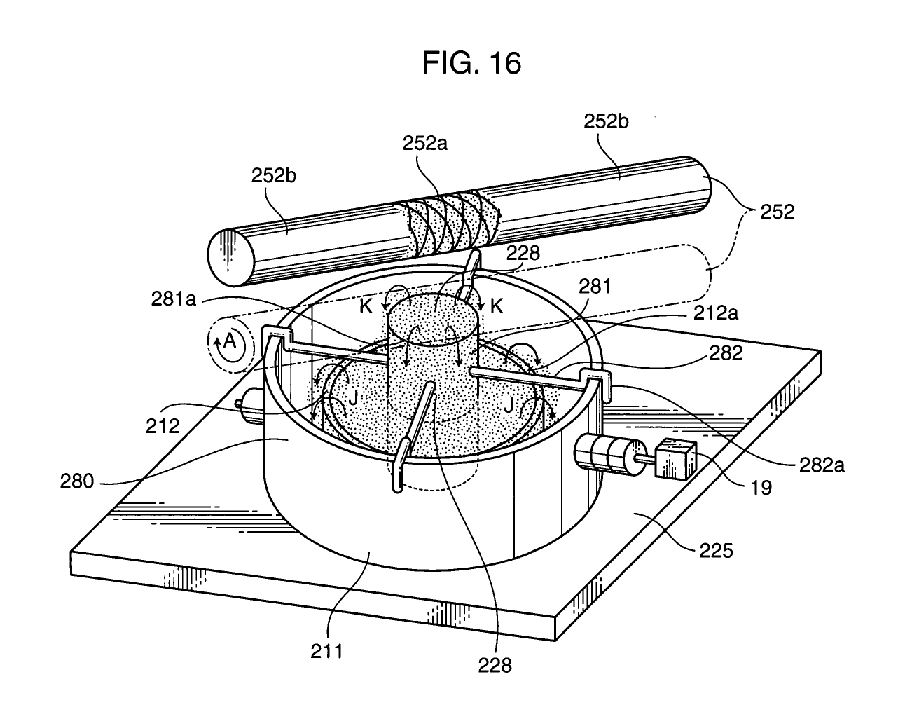

FIG. 15 is a schematic cross sectional view of a coating apparatus 280 according to Embodiment 6 of the present invention in use, and FIG. 16 is a perspective view showing a method for coating locally on a bar of the metal substrate 252 using the coating apparatus 280. For constitutional components identical to those shown in FIGS. 2 to 6, the same numbers are allocated to exclude repeated description.

The inner container (cylinder) 212 according to Embodiment 6 is cylindrical in shape and the top of the container is cut open. The powder 228 contained inside (in the ascending region 213) overflows the top edge, i.e., the first overflow edge of the inner container.

The inner container 212 has at the center an additional inner cylinder (ascending fluid guide) 281. The inner cylinder 281 is also cylindrical in shape, the lower end thereof 281b being embedded in the powder 228 contained in the inner container 212 and the top end thereof (the second overflow edge) 281a being disposed at a position higher than that of the top edge 212a of the inner container 212. The outer width of the top edge of inner cylinder 281a is slightly smaller than the coating width of a substrate. The inner cylinder 281 is removably disposed on the top of the outer container 211, supported by the supporting rods 282. The supporting rods 282 extend from the inner cylinder 281 and firmly grabs the sidewall of the outer container 211 at the end 282a thereof.

Hereinafter, a method for coating a powdery masking agent on a metal substrate (substrate) using the coating apparatus of Embodiment 6 will be described. In a similar manner to Embodiment 2, the powder 228 in the descending region 214 is conveyed via connecting holes 16 by the rotation of screws 217_{R} and 217_{L} into the ascending region 213 (inside the inner container 212) (arrow F), and as the powder 228 is steadily supplied via connecting holes 16, the powder 228 in the ascending region 213 is pushed upward (arrow C). The vertical screw 229 is not disposed in the coating apparatus 280 of Embodiment 6 and the powder 228 migrates upward only by the force of feeding the powder via connecting holes 16.

The part of ascending the powder 228 migrating to outside the inner cylinder 281 overflows the top edge 212a of the inner container (first overflow edge) (arrow J), while the other part of the powder 228 migrating inside the inner cylinder 281 overflows the top edge 281a of the inner cylinder (second overflow edge) (arrow K). The powder 228 overflowing the top edge 212a of the inner container reaches the descending region 214, while the powder 228 overflowing the top edge 281a of the inner cylinder falls onto the upper surface of the powder 228 in the inner container 212 and subsequently overflows the inner container 212 into the descending region 214. The powder slides down along inclined guide 15 to the connecting holes 16 (arrow E). The powder then returns into the ascending region 213 (arrow F), migrates upward in the ascending region 213 (arrow C), and overflows the top edge 212a of the inner container and the top edge 281a of the inner cylinder (arrows J and K). In this manner, the powder 228 keeps circulating (in the fluid circulation system).

As the inner container 212 and the inner cylinder 281 are both cylindrical in shape, a horizontal force is not applied to ascending the powder 228. Accordingly, the powder 228 does not form clumps and smoothly overflows the top edge 212a of the inner container and the top edge 281a of the inner cylinder.

As the powder 228 also keeps circulating in the coating apparatus of Embodiment 6, the powder 228 is present on the top edge 281a of the inner cylinder overflowing the inner cylinder 281 in a certain uniform shape without being scattered as in the case of the fluidized bed method described above. As the powder 228 is present in a protrusive state on the top edge 281a of the inner cylinder confined to a relatively area of slightly larger than that of the top edge 281a of the inner cylinder, it is possible to coat (mask) the powder locally on a specific region of metal substrate (substrate) 252, with a definite dividing line between the masking and non-masking regions, by bringing the metal substrate into contact with the powder 228 overflowing the top edge 281a of the inner cylinder (as shown as 2 dotted and dashed line in FIG. 16).

In a similar manner to the embodiments above, it is preferable to heat the metal substrate 252 in advance of the masking, so as to allow the powder 228 to fuse and bond in contact with the metal substrate. Similarly, the outer diameter of the top edge 281a of the inner cylinder is preferably slightly smaller than the coating width of the metal substrate 252, so that the width of the overflowing powder becomes identical to the coating width of the metal substrate. Additionally, micro-vibration of the powder 228 by bringing vibrator board 225 in operation is effective for smoother flowing of the powder 228 over top end of the inner container 281.

### Embodiment 7

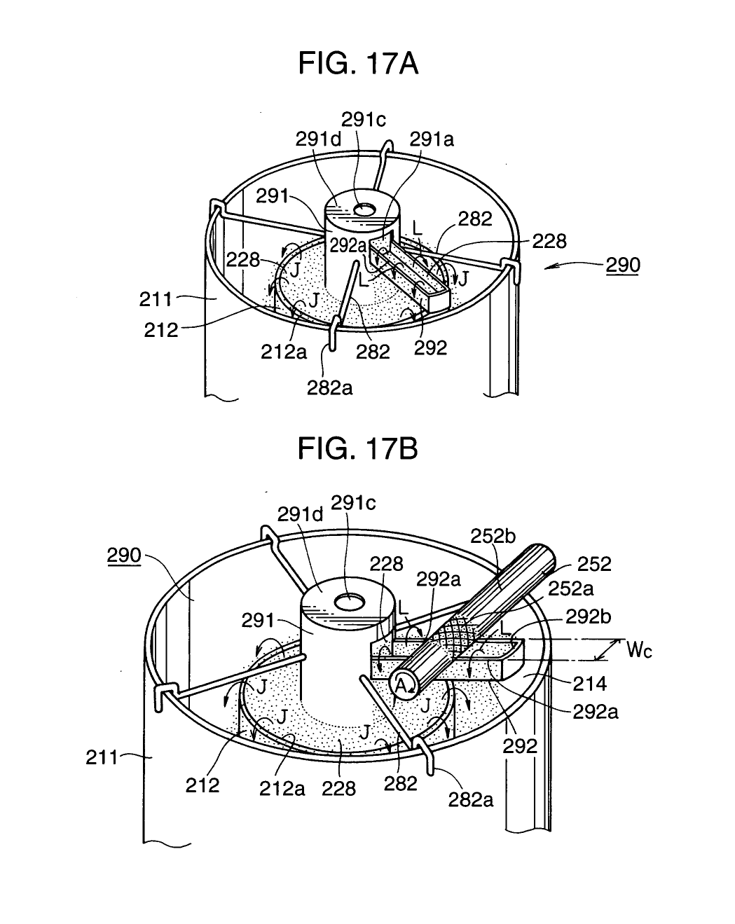

FIG. 17(a) is a fragmentary perspective view of a coating apparatus 290 according to Embodiment 7 of the present invention in use, and FIG. 17(b) is a fragmentary perspective view showing a method for locally coating a bar of the metal substrate 252 in the coating apparatus 290. For constitutional components identical to those shown in FIGS. 15 and 16, the same numbers are allocated to exclude repeated description.

The inner container 212 according to Embodiment 7 is also cylindrical in shape in a similar manner to Embodiment 6 above and the top of the cylinder is cut open (first overflow edge), allowing the powder 228 contained inside (in the ascending region 213) to overflow.

In addition, the inner container 212 has an inner cylinder (ascending fluid guide) 291 at the center. The inner cylinder 291 is cylindrical in shape, having an opening 291a in the sidewall and a gutter component 292 sticking out therefrom. The gutter component 292 sticks out horizontally at a position higher than the top edge 212a of the inner container. The outer width (W_{C}) of the top edge 292a of the gutter component is slightly smaller than the coating width of the substrate. The bottom of the inner cylinder 291 (not shown in the Figure) is inserted in the powder 228 contained in the inner container 212 in a similar manner to Embodiment 6 above. A cap 291d having a hole 291 is disposed atop the inner cylinder 291.

The coating apparatus of Embodiment 7 is essentially same as that of Embodiment 7, except that the inner cylinder of Embodiment 6 is replaced with the cylinder of the present embodiment, and in this way, the inner cylinder may be suitably changed according to the shape of the substrate.

Hereinafter, a method for coating a powdery masking agent on a metal substrate (substrate) in the coating apparatus 290 of Embodiment 7 will be described.

In a similar manner to Embodiment 6, a the powder 228 in the inner container 212 is always migrating upward. The part of ascending the powder 28 migrating outside the inner cylinder 291 overflows the top edge 212a (first overflow edge) of the inner container (arrow J). The other part of the powder 228 migrating inside the inner cylinder 291 reaches the gutter component 292 via an opening 291a of the inner cylinder 291. The powder 228 pushed into the gutter component 292 flows in the gutter component 292 in its longitudinal direction and overflows the top edge 292a of the gutter component (arrow L). Overflowing the powder 228 falls into either the inner container 212 (ascending region) or into the descending region 214, and the powder dropped into the inner container 212 further overflows the top edge 212a of the inner container into the descending region 214. In a similar manner to the embodiments above, the powder is conveyed back from the bottom of the descending region 214 into the inner container 212 (ascending region) and repeats circulating (in the fluid circulation system).

Although the powder 228 may not reach other end 292b of the gutter component 292 or move only to a position not significantly far from the opening 291a in the gutter component 292, it is sufficient for coating of the metal substrate 252.

As the powder 228 keeps circulating in Embodiment 7 as well, the powder is always present on the gutter component 292 overflowing the top edge 292a thereof in a certain uniform shape without being scattered as in the case of the fluidized bed method described above. As the powder 228 is present in a protrusive state on the gutter component 292 with a relatively confined area of slightly larger than width W_{C} of the gutter component 292, it is possible to coat (mask) the powder locally on a specific region of the metal substrate (substrate) 252 with a definite dividing line between the masking region and non-masking region, by bringing the metal substrate into close proximity of and contact with the powder 228 overflowing the gutter component 292 (FIG. 17(b)).

Additionally in the coating apparatus according to Embodiment 7, it is possible to coat on a very narrow region of substrate by the use of a narrow gutter component.

### Embodiment 8

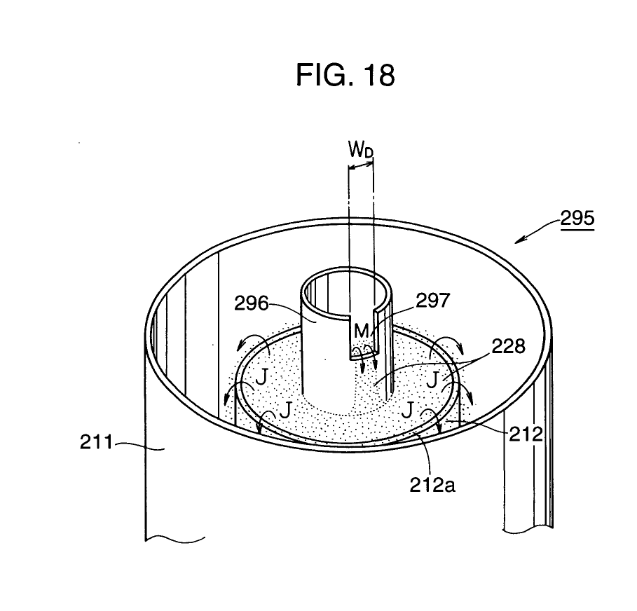

FIG. 18 is a fragmentary perspective view of a coating apparatus 295 according to Embodiment 8 of the present invention in use. For constitutional components identical to those shown in FIGS. 15 and 16, the same numbers are allocated to exclude repeated description.

In a similar manner to Embodiments 6 and 7 above, an inner cylinder 296 cylindrical in shape is disposed at the center of an inner container 212 also cylindrical in shape. The inner cylinder 296 has a rectangular notch (opening) 297 in the sidewall at a position higher than the top edge of the inner container 212, and a the powder 228 migrating upward in the inner cylinder 296 flows out of the notch 297 (arrow M). Subsequently, the powder falls onto the powder in the inner container 212, which, together with the powder 228 migrating upward outside the inner cylinder 296 in the inner container 212, overflows the top edge 212a of the inner container into the descending region 214. The powder is then fed back from the bottom of the descending region 214 into the inner container 212 and keeps circulating. The inner cylinder 296 according to Embodiment 8 is disposed in the inner container 212, securely connected to the inner wall thereof. The bottom of the inner cylinder 296 (not shown in the Figure) is inserted in the powder 228 contained in the inner container 212 in a similar manner to Embodiment 6.

As the powder 228 keeps circulating in Embodiment 8 too, the powder is always present in the inner cylinder 296 flowing out of notch 297 (arrow M) in a certain uniform shape without being scattered. As the powder 228 is flowing out of notch 297 in a protrusive state at a position higher than the powder 228 in internal container 212, with a relatively confined area of slightly larger than the width WD of the notch, it is possible to coat (mask) the powder locally on a specific region of the metal substrate (substrate) 252 with a definite dividing line between the masking region and non-masking regions, by bringing the metal substrate into close proximity of and contact with the powder 228 flowing out of the notch.

Additionally in the coating apparatus according to Embodiment 8, it is also possible to coat on a very narrow region of substrate by reducing the width of notch 297.

### Embodiment 9

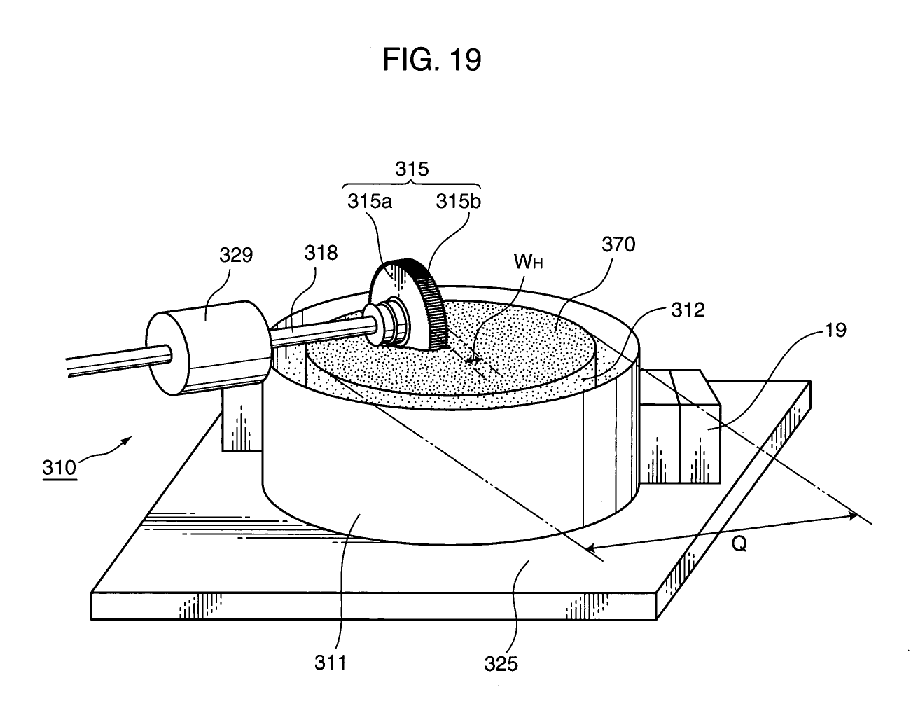

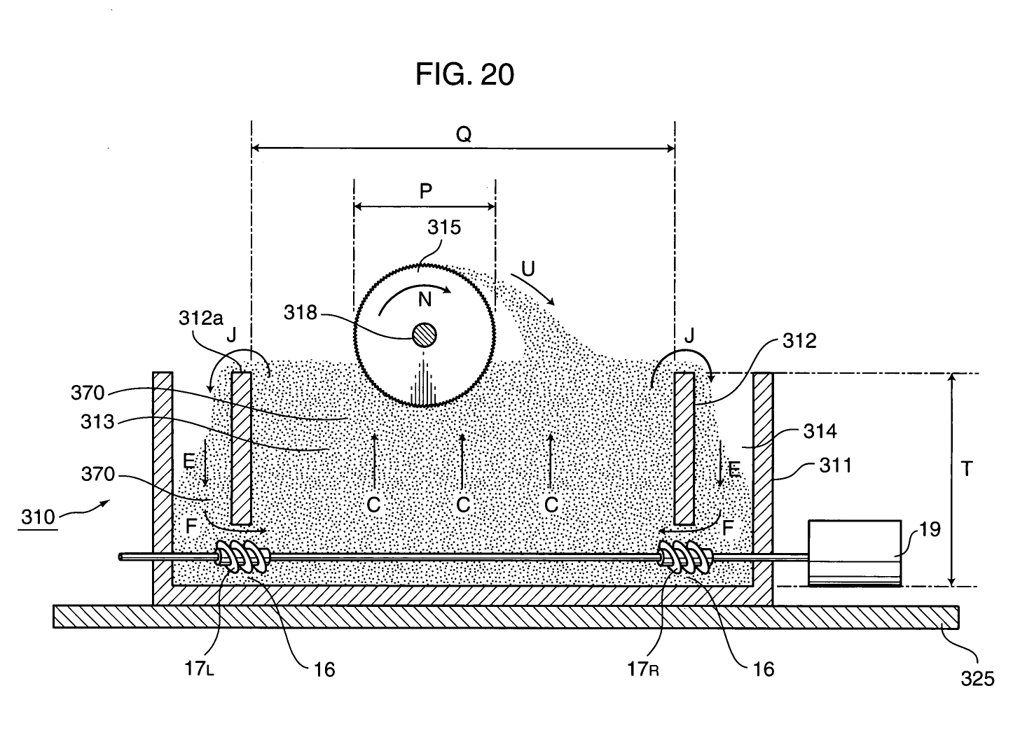

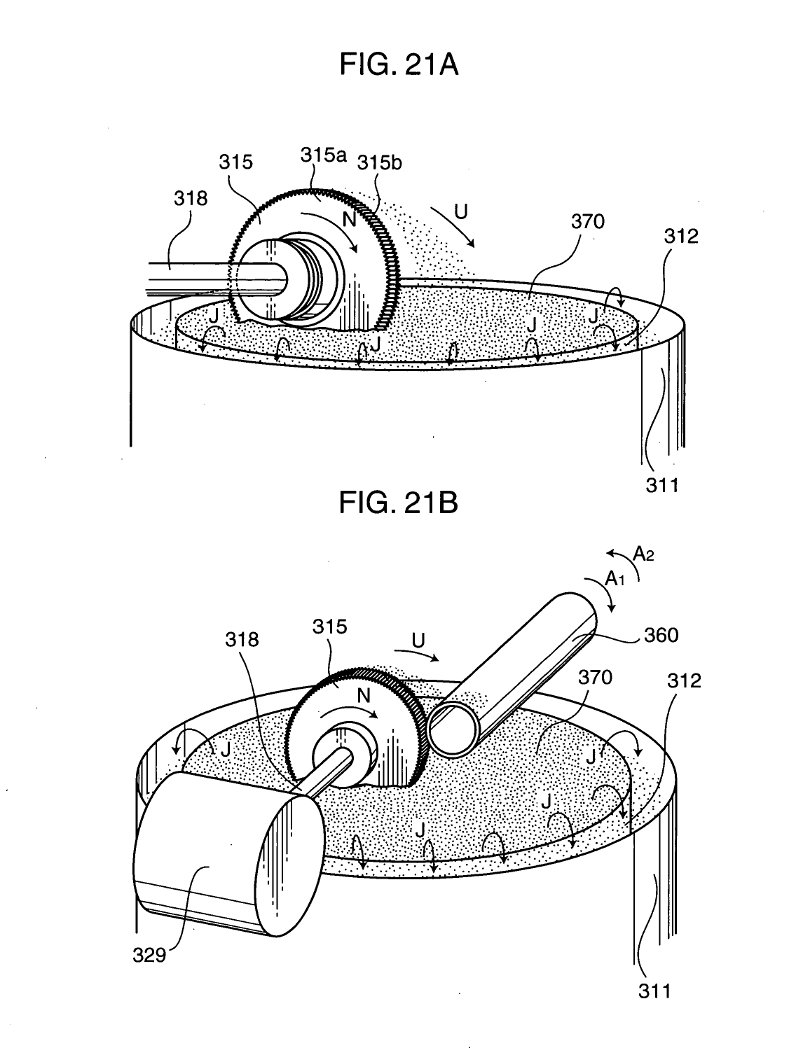

FIG. 19 is a perspective view of a coating apparatus 310 according to Embodiment 9 of the present invention, and FIG. 20 is a schematic longitudinal sectional view of coating apparatus 310. Additionally, FIG. 21 is a perspective view showing a masking method using coating apparatus 310.

Coating apparatus 310 comprises a cylindrical outer container (overflow fluid receiving container) 311 and a cylindrical inner container (dipping container) 312 disposed inside the outer container 311, wherein the part inside the inner container 312 represents the ascending region 313 and the gap between the outer wall of the inner container 312 and the inner wall of the outer container 311 represents descending region 314. The outer container 311 is connected onto a vibrator board 325 and the inner container 312 is connected to the outer container 311. The depth T and the diameter Q of the inner container 312 are respectively 100 mm and 200 mm. Two connecting holes 16 are disposed at the lower part close to the bottom of the inner container 312 and two screws 17_{R} and 17_{L} are placed in the connecting holes, connected to a rotational shaft penetrating the connecting holes. The rotational shaft having screws 17_{R} and 17_{L} is connected to an external motor 19.

Additionally, a spur gearwheel 315 is disposed at the top of the inner container 312. The rotational axis of the spur gearwheel 315 is aligned in the direction parallel to the top surface of a powder 370 contained in the inner container 312, and about half of the spur gearwheel 315 is inserted into the powder 370 contained in the inner container 312. A rotational shaft 318 corresponding to the rotational axis of the spur gearwheel 315 is connected to a motor 229 [sic 329], and the spur gearwheel 315 rotates (arrow N) by means of the motor 329. The external diameter P of the spur gearwheel 315 is 60 mm; the thickness W_{H} (the width of cogs of the gearwheel) is 10 mm; the cogs on the circumferential surface 315b of the spur gearwheel 315 are straight in the direction parallel to the rotating axis; the height of the cogs (cog depth) is 2 mm; and the pitch thereof is 1.6 mm. Further, the side surfaces of the spur gearwheel 315 are smooth (for example, the surfaces are preferably processed with polytetrafluoroethylene). The spur gearwheel 315, rotational shaft 318, and the motor (driving part) 329 constitute the conveying means described above.

Hereinafter, a method for masking a tubular material 360 using the coating apparatus 310 will be described.

The powder 370 having a main diameter of 120 μm and a repose angle of 40 degree is placed in the container.

As shown in FIG. 20, the powder in the descending region 314 is conveyed via connecting holes 16 by the rotation of screws 17_{R} and 17_{L} into the inner container 312 (ascending region 313)(arrow F); the powder 370 contained in the inner container 312 is pushed upward by the powder thus supplied (arrow C) and the overflows edge 312a (arrow J) into the descending region 314 (arrow E). Subsequently, the powder 370 enters via connecting holes 16 into the inner container 312 (arrow F) and ascends in the inner container 312 (arrow C). In this manner, the powder 370 keeps circulating between the ascending region 313 and the descending region 314, the overflowing edge 312a and maintaining the top surface of the powder in the ascending region 313 (in the inner container 312) at a particular level. By the circulation, the powder 370 in the ascending region 313 flows gently as if stirred, preventing formation of lumps or voids in the powder 370. Additionally, micro-vibration by the vibrator board 325 (e.g., vibration with a reciprocating width of 2 mm) keeps the top surface of the powder 370 at a still more consistent height.

The spur gearwheel 315 is rotating at a speed of 260 to 300 rpm by means of the motor 29 [sic 329] (arrow N), allowing the circumferential surface 315b of the spur gearwheel to scoop up the powder 370 present in the upper part of the ascending region 313 (in the inner container 312) and to throw the powder in the direction of arrow U (FIG. 20, FIG. 21(a)). The powder 370 thrown in the direction of arrow U has a width relatively narrower than that of the above-described sprinkling method, allowing coating on the substrate 360 in a predetermined width. A hole in the powder 370 formed by the scoop of the spur gearwheel 315 is quickly filled with the powder 370 as it is migrating upward in the circulation system described above and by the vibration of the vibrator board 325, and thus there is actually no hole generated, allowing the spur gearwheel 315 to scoop up the powder constantly in a constant amount. Additionally, as the powder 370 in the ascending region 313 does not form lumps or voids as described above, the spur gearwheel 315 does not scoop up the lumps and the like or encounter the voids that impede scooping up of the powder. As the spur gearwheel 315 always scoops up a constant amount of the powder in this manner, the amount of the powder thrown in the direction of arrow U is also kept almost at a constant level.

As the side surfaces 315a of the spur gearwheel 315 are smooth, the powder 370 does not attach thereto and therefore the powder 370 does not be scooped up by the side surfaces 315a.

By bringing a tubular substrate 360 previously heated into close proximity of the powder 370 thrown in the direction of arrow U (by bringing substrate 360 in close proximity of the rotational shaft of the spur gearwheel 315 in such a way that the axes of the gearwheel 315 and the tubular substrate 360 become parallel) and by rotating the tubular substrate 360 (arrow A₁ or A₂), the powder is coated on the surface around the tubular substrate (FIG. 21(b)). The rotational direction of the tubular substrate 360 may be identical to that of the spur gearwheel 315 (arrow A₁) or opposite thereto (arrow A₂). Alternatively, the tubular substrate may be rotated in the identical direction (or the opposite direction) for a period and then in the opposite direction (or the identical direction) for another period of time thereafter.

In this way, masking on the outer surface of the substrate 360 is completed. By the use of the coating apparatus 310 according to Embodiment 9, it is possible to coat a fluid such as a powder and the like onto the outer surface of a tubular substrate, practically without coating on the inner or end surface of the tubular substrate. Additionally, the coating apparatus according to Embodiment 9 is useful for coating selectively on a central portion of the tubular substrate, more specifically, for masking of a tubular substrate, only on a central portion but not on the portions close to both ends thereof.

### Embodiment 10

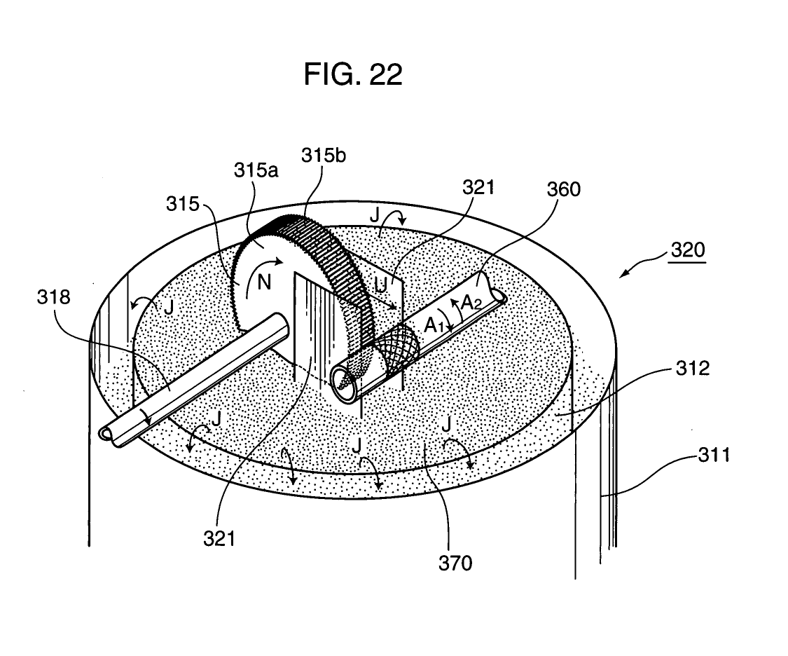

FIG. 22 is a perspective view of a part of a coating apparatus 320 according to Embodiment 10 of the present invention and a substrate 360. For constitutional components identical to those shown in FIGS. 19 to 21, the same numbers are allocated to exclude repeated description.

The coating apparatus 320 according to Embodiment 10 has, at a location in proximity of the side surfaces 315a of a gearwheel and where a powder is thrown, additional two guide plates 321 arranged in the direction parallel to the side surfaces 315a of the spur gearwheel 315, and has a configuration same as that of the coating apparatus 310 according to Embodiment 9 except these guide plates.

In a similar manner to Embodiment 9, the powder 370 is thrown (arrow U) by the rotation of the spur gearwheel 315 (arrow N) and is coated on a certain outer side surface of a substrate 360. The powder 370 thrown from the circumferential surface 315b of the spur gearwheel 315 falls in an area confined by the guide plates 321, resulting in coating on a distinct coating region of the substrate 360, in other words, enabling to establish a well-defined dividing line between the masking and non-masking regions.

As the guide plates 321 do not come into contact with the spur gearwheel 315, there are no undesirable effects as a result of the rotation of the spur gearwheel 315.

### Embodiment 11

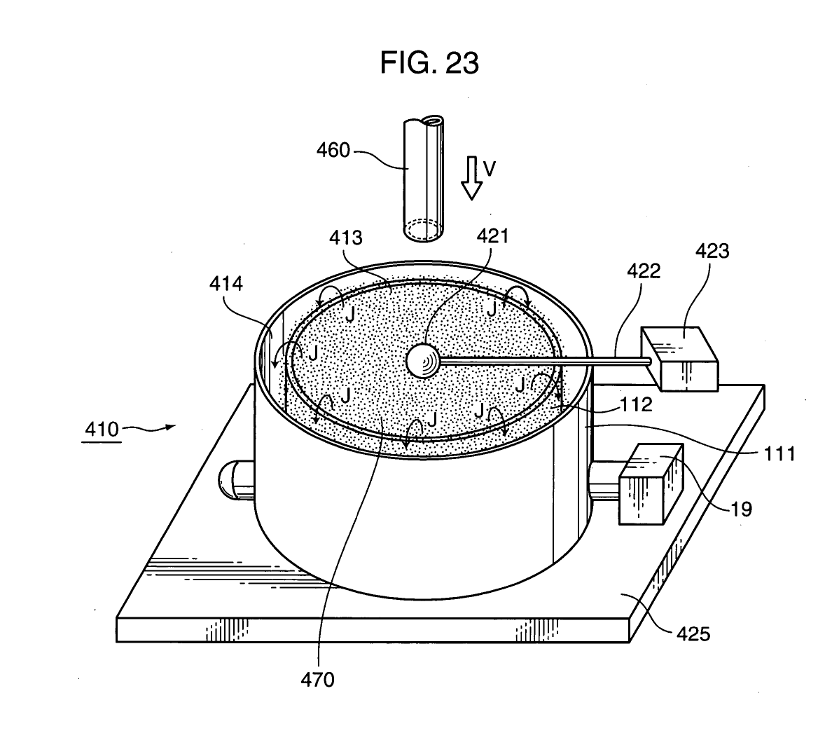

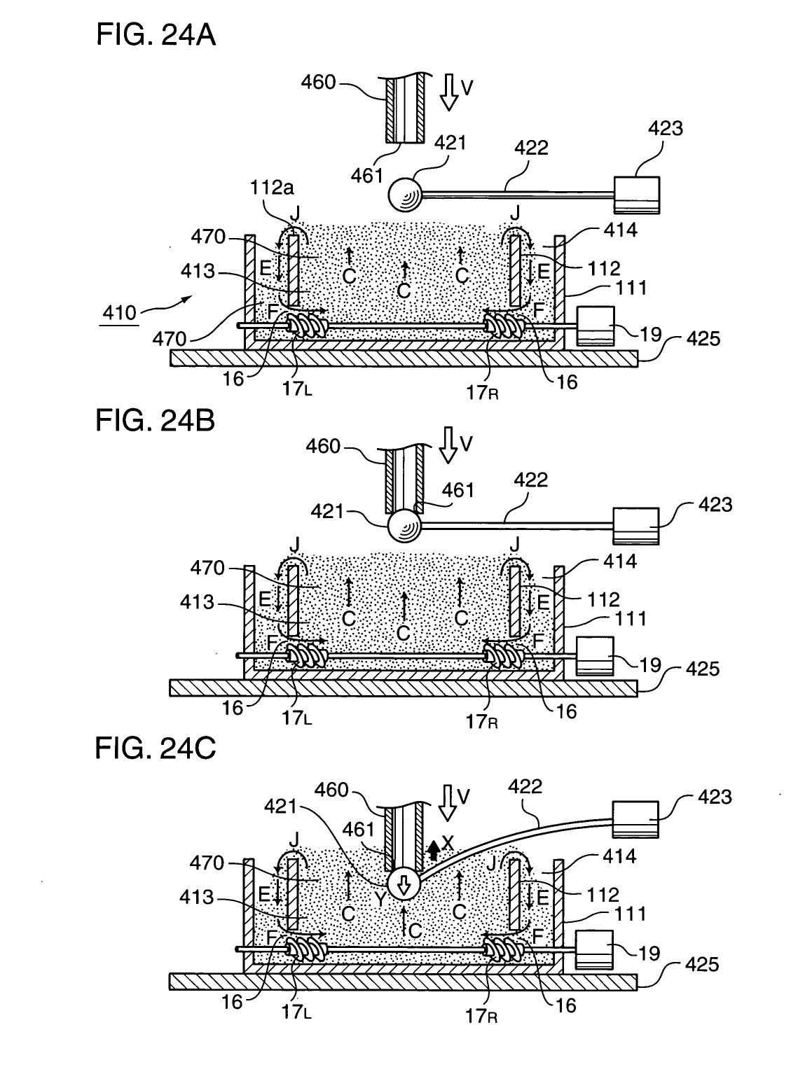

FIG. 23 is a perspective view of a coating apparatus 410 according to Embodiment 11 of the present invention and a substrate 460; FIG. 24 is a cross sectional view showing a masking method using coating apparatus 410; and FIG. 24(a) corresponds to a vertical cross sectional view of FIG. 23. For constitutional components identical to those shown in FIG. 1, the same numbers are allocated to exclude repeated description.

The coating apparatus 410 comprises a cylindrical the outer container 111 and a cylindrical the inner container 112 disposed inside the outer container 111, wherein the portion inside the inner container 112 represents the ascending region 413 and the gap between the outer wall of the inner container 112 and the inner wall of the outer container 111 represents the descending region 414. The outer container 111 is connected onto a vibrator board (microvibrator) 425, and the inner container 112 is connected to the outer container 111.

Additionally, a bar spring 422 is disposed horizontally in the direction parallel to the top surface of powder 470 contained in the inner container 112. The bar spring 422 is connected to a base component 423 at one end and to a spherical sealing component 421 at the other end. The spherical sealing component 421 is placed above the top surface of a powder 470 at a certain distance. The spherical sealing component 421, bar spring 422, and base component 423 combined constitute a sealing means for sealing an opening of a substrate.

Hereinafter, a method to mask a tubular substrate 460 using the coating apparatus 410 will be described.

The powder 470 contained in the inner container 112 migrates upward in the inner container 112 by means of screws 17_{R} and 17_{L} (arrow C) and overflows the overflow edge 112a (arrow J) into the descending region 414 (arrow E). Subsequently, the powder enters via connecting holes 16 disposed close to the bottom into the inner container 112 (arrow F) and ascends in the inner container 112 (arrow C). In this manner, the powder 470 keeps circulating between the ascending region 413 and the descending region 414 and overflowing from the overflow edge 12a [sic 112a]. Additionally, microvibration of a vibrator board 425 (e.g., vibrational frequency of twice/sec, amplitude of 1 mm (2 mm reciprocally)) allows the top surface of powder 470 to be kept at a more consistent and flat level.

A tubular substrate 460 is gradually brought from above toward the powder 470 contained in the ascending region 413 (arrow V), and into contact with the spherical sealing component 421, so that the opening 461 in the tubular substrate 460 is closed (FIG. 24(b)). The tubular substrate 460 is further pushed downward into the powder 470 (arrow V) until the substrate 460 is inserted to a certain position (FIG. 24(c)). The substrate is inserted into the powder 470 (arrow Y), with the opening 461 being securely capped with the spherical sealing component 421 by the strain of the bent bar spring 422 (arrow X). As the powder 470 keeps migrating upward, a hole generated by the insertion of the bar spring into the powder 470 can be immediately filled and the powder 470 keeps its original height.

By keeping the substrate inserted for a certain period (e.g., 5 seconds) allowing the powder 470 to fuse and bond onto the outer side surface close to the lower end of the substrate 460 and the lower end surface thereof and by withdrawing the substrate 460 from the powder, masking is completed. During the withdrawal, the bar spring 422 keeps pressing the spherical sealing component 421 to the opening 461 by the strain (arrow X), preventing migration of the powder 470 into the internal cavity of the substrate 460.

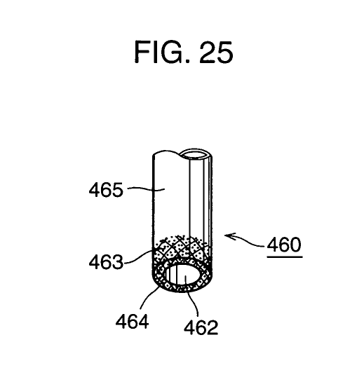

As shown in FIG. 25 (a perspective view of a masked tubular substrate), masked the tubular substrate 460 does not have the inner side surface 462 coated with the powder 470, but has an outer side surface close to an end 463 and the end surface 464 coated (masked) with the powder. Additionally, the top surface of the powder 470 is kept at a certain height, the masked portions (outer side surface 463 close to an end, and end surface 464) and the non-masked portions (the central portion of the substrate 465 and inner side surface 464) are established definitely at a particular position.

As the spherical sealing component 421 and the bar spring 422 are lifted above the powder 470 when such a powder-coating operation is not conducted (FIG. 24(a)), they do not have any undesirable effects on the flow of the powder 470, eliminating a concern about formation of lumps and voids in the powder 470.

In this manner, in the coating apparatus according to Embodiment 11, it is possible to coat a fluid (powder) only on the outer surface of a substrate having an opening, for example, a tubular substrate, without coating the fluid onto the internal surface of the opening. By a proper design of the shape of the sealing component 421, it is possible to mask a fluid only on a particular masking portion, without masking the fluid onto a local non-masking portion of the substrate. Further, the method eliminates the time-consuming labor required for the conventional brushing method and provides a distinct borderline between the masking and non-masking regions in contrast to the sprinkling method.

### Embodiment 12

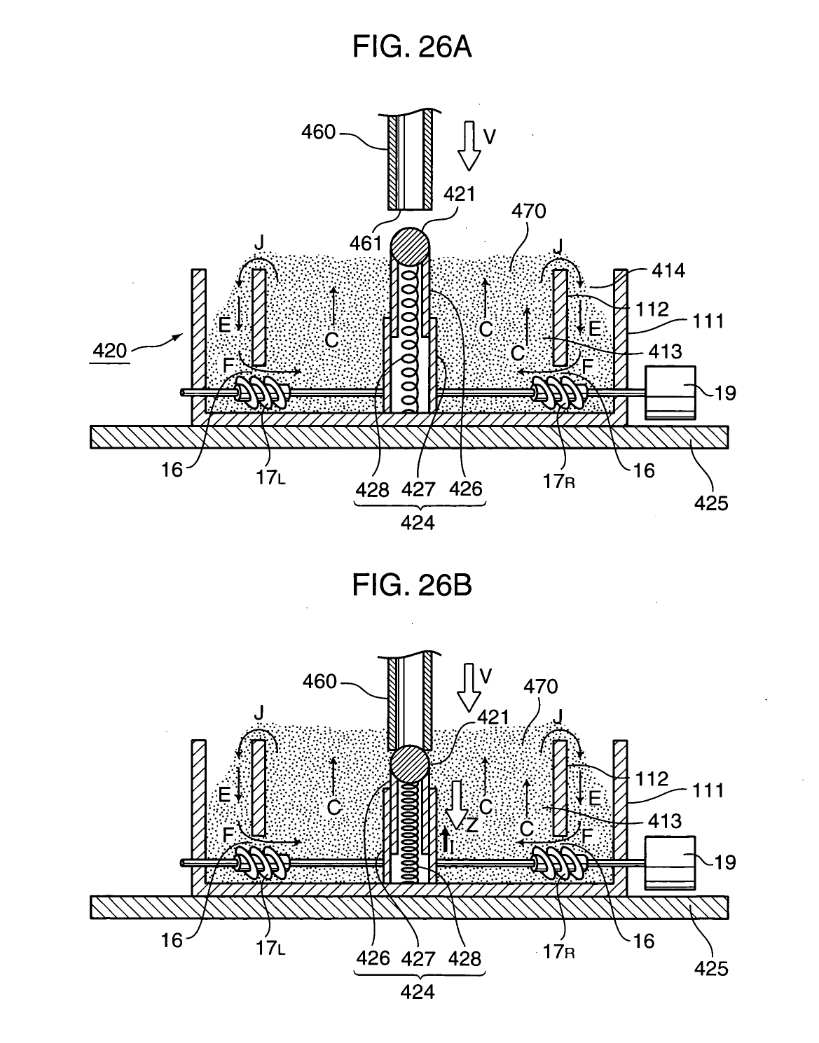

FIG. 26 is a cross sectional view of a coating apparatus 420 according to Embodiment 12 of the present invention and a tubular substrate 460. For constitutional components identical to those shown in FIGS. 23 and 24, the same numbers are allocated to exclude repeated description.

At the bottom of an the inner container 112, a spring component 424 is disposed at a position avoiding screws 17_{R} and 17_{L} and the relevant shaft, and a spherical sealing component 421 is placed at the top of spring component 424. The spherical sealing component 421 is exposed, sticking out of the top surface of a the powder 470.

The spring component 424, comprising a dual tube portion consisting of an inner tube 426 and an outer tube 427 and a spiral spring 428 inserted therein, varies in length (height) by expansion or contraction of the spiral spring 428 and by the sliding of inner tube 426 into the outer tube 427.

During an operation for masking a tubular substrate 460, the tubular substrate 460 is advanced downward in V direction as shown in the Figure, allowing the spherical sealing component 421 to fit to and close an the opening 461 of the tubular substrate 460, and further inserted into the powder 470. The spring component 424, being contracted by the insertion of the substrate 460 (arrow Z), keeps pushing the spherical sealing component 421 to the opening 461 by its repulsive force (arrow I).

After keeping the substrate 460 inserted in the powder 470 for a predetermined period, allowing the powder to fuse and bond onto outer side surface close to an end 463 and the end surface 464 of the substrate 460, the substrate is withdrawn. As the spring component 424 keeps pushing the spherical sealing component 421 to the opening 461 by its repulsive force (arrow I) during the withdrawal, the powder 470 does not migrate into the internal cavity of the substrate 460. In this way, masking is completed.

In a similar manner to Embodiment 11, in the coating apparatus 420 of Embodiment 12 too, a masked tubular substrate 460 does not have an inner side surface 462 of the cylinder coated with the powder 470, but has an outer side surface 463 close to an end and the end surface 464 coated with the powder, as shown in FIG. 25.

### Embodiment 13

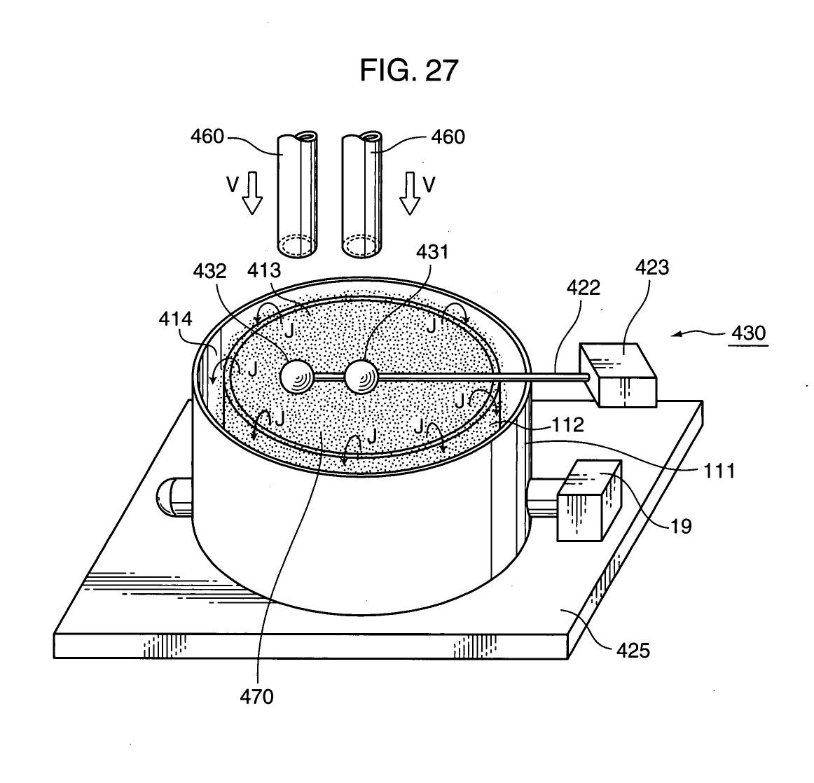

FIG. 27 is a perspective view of a coating apparatus 430 according to Embodiment 13 of the present invention and a tubular substrate 460. For constitutional components identical to those shown in FIGS. 23 and 24, the same numbers are allocated to exclude repeated description.

The coating apparatus 430 according to Embodiment 13 has two spherical sealing components 431 and 432 connected to a bar spring 422 and a configuration identical to that of the coating apparatus 410 according to Embodiment 11 except these spherical sealing components.

In the coating apparatus according to Embodiment 13, two tubular substrates 460 can be masked simultaneously.

### Embodiment 14

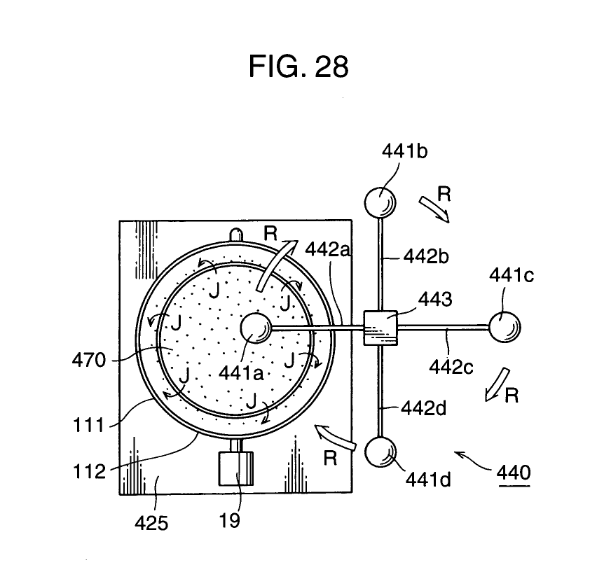

FIG. 28 is a top view of a coating apparatus 440 according to Embodiment 14 of the present invention. For constitutional components identical to those shown in FIGS. 23 and 24, the same numbers are allocated to eliminate repeated description.

The coating apparatus 440 according to Embodiment 14 has four bar springs 442a, 442b, 442c, and 442d connected in a radial arrangement to a rotatable base component 443, and to bar springs 442a, 442b, 442c, and 442d are attached respectively spherical sealing components 441a, 441b, 441c, and 441d. The coating apparatus has a configuration identical to that of the coating apparatus 410 of Embodiment 11 except for the sealing components and the like above.

At first, a tubular substrate (not shown in the Figure) is masked using a set of the spherical sealing component 441a and the bar spring 442a in a similar manner to Embodiment 11. After the substrate is withdrawn from the powder 470 after completion of the masking, the base component 443 is rotated (arrow R), allowing the next set of the spherical sealing component 441d and the bar spring 442d to come above the powder 470 contained in the inner container 112. Subsequently, the next tubular substrate is masked using the set of the spherical sealing component 441d and the bar spring 442d. In this manner, a spherical sealing component is exchanged with another by rotating the base component 443 and the masking is continued.

While the spherical sealing components and the bar springs (spherical sealing components 441b, 441c, and 441d and bar springs 442b, 442c, and 442d in FIG. 28) are not in use, the powder attached to these components is removed (cleaned), allowing the use of a set of the spherical sealing component and bar spring that is always kept clean. The methods for removing the powder include, for example, a method by solidification of the attached powder under cooling and subsequent removal of the solidified powder.

A large amount of the powder may be attached at times to the spherical sealing component during a single masking operation. If present in such a large amount, the powder attached to the spherical sealing component may be transferred to the substrate in the next round of masking operation, raising a concern over a problem that an undesired portion of the substrate may be masked and the thickness of the masked film becomes too large or small locally. However, the coating apparatus according to Embodiment 14, wherein the spherical sealing components and bar springs are repeatedly cleaned, does not cause the problem of the undesirable powder attachment.

### Embodiment 15

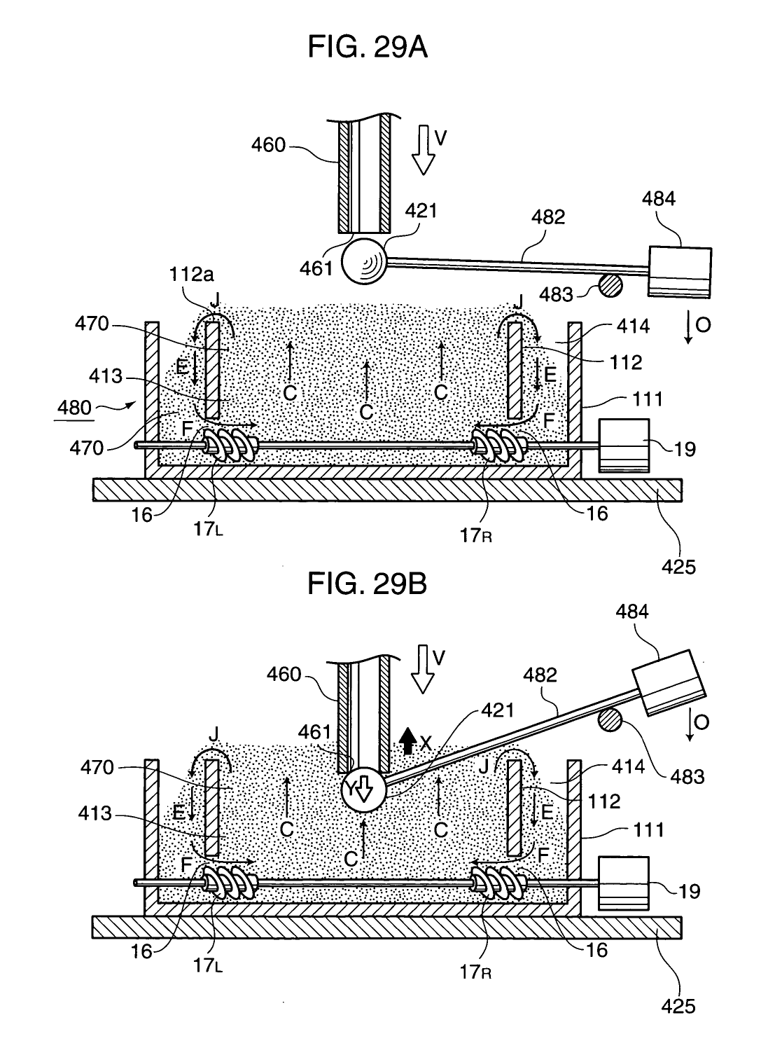

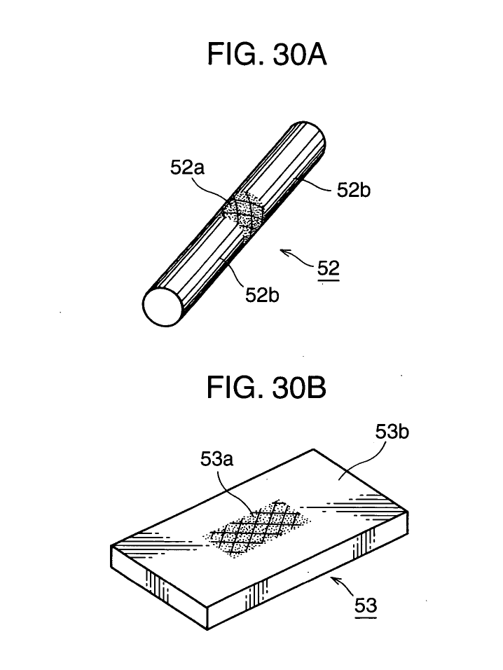

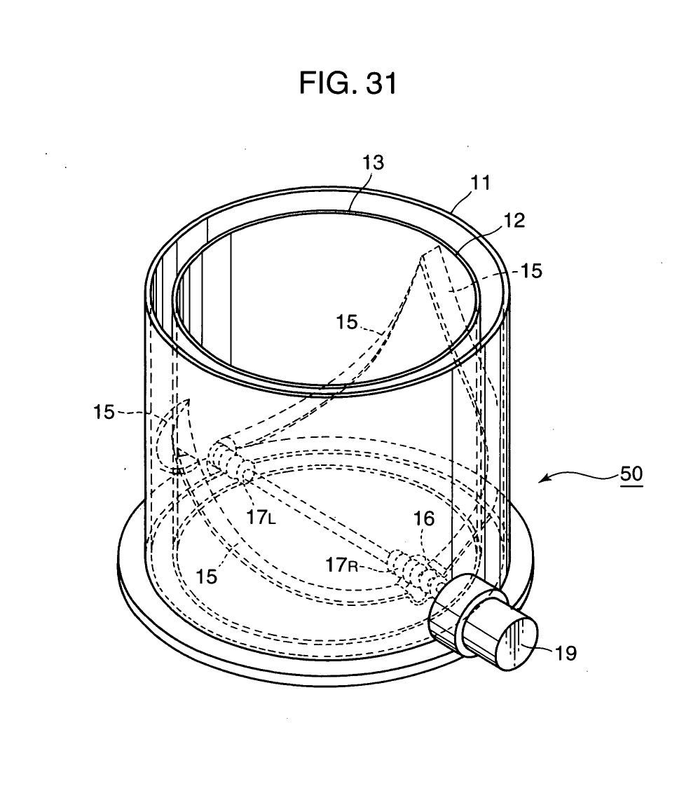

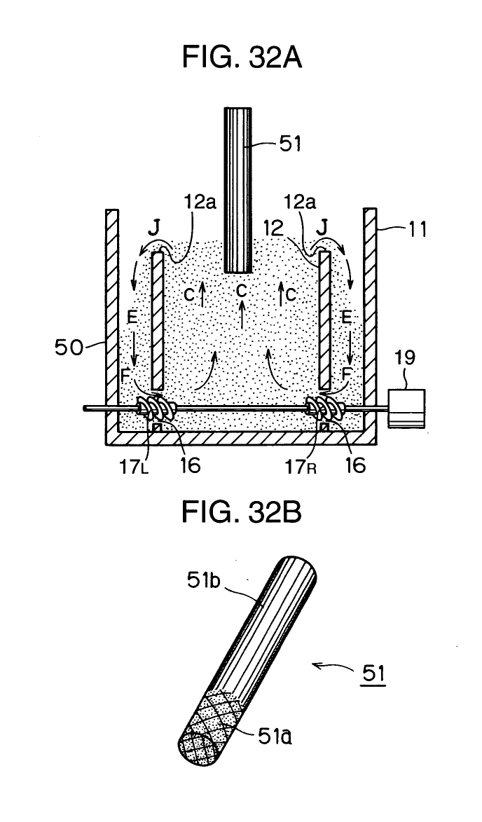

FIG. 29 is a sectional view of a coating apparatus 480 according to Embodiment 15 of the present invention and a tubular substrate 460. For constitutional components identical to those shown in FIGS. 23 and 24, the same numbers are allocated to exclude repeated description.

A rod 482 is disposed above the powder 470 contained in an inner container 112 horizontally in the direction parallel to the tope surface thereof. The rod 482 is made of a rigid material and has a weight 484 connected to the tail end and a spherical sealing component 421 at the head end thereof. The rod 482 is supported by and connected to a base component 483 located at a position inward from but close to the weight 484, and the sealing component 421 moves up and down with respect to the base component 483, i.e., the supporting point.

During an operation for masking a tubular substrate 460, the tubular substrate 460 is advanced downward (in V direction) in a similar manner to Embodiment 11 and the like above (FIG. 29(a)), allowing the spherical sealing component 421 to fit to and close an the opening 461 of the tubular substrate 460, and further inserted into the powder 470 (FIG. 29(b)). As rod 482 pushes the sealing component 421 in the direction of arrow X by the force of the weight 484 (in the direction of arrow O) with respect to the base component 483, i.e., the supporting point, the substrate 460 is inserted into the powder 470 (arrow Y) as the opening 461 thereof is being capped with the spherical sealing component 421 by the pressing force. During the substrate 460 is not inserted into the powder 470, the sealing component 421 stays above the top surface of the powder by the force of the weight 484 (FIG. 29(a)).

The coating apparatus of the present invention is described above specifically with reference to Figures showing a variety of embodiments, but the present invention is not limited to the embodiments shown in the figures. It is possible to work the present invention with a modification within the scope of the purpose of the present invention and such modifications are also included in the technical scope of the present invention.

For example, although a powder is used as an example of the fluid of the present invention in the embodiments above, the fluid of the present invention is not limited to powders but includes flowable materials such as pastes.

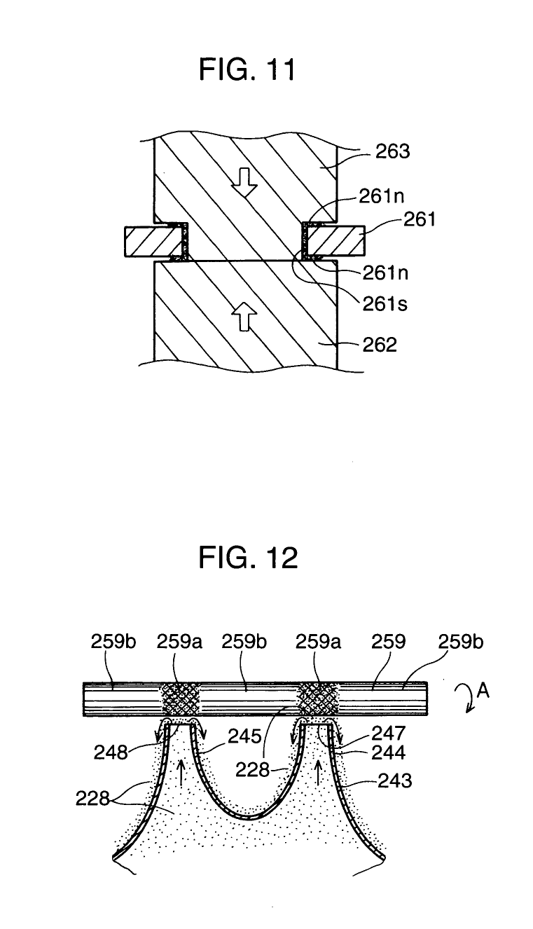

In addition, after the metal substrate (substrate) is coated with a powder, the masking portion of the coated substrate may be further heated in a heater to ensure heat fusion and bonding of the powder. For example, in the case of a gear of the metal substrate 261 shown in FIG. 10, the masked portions of the gear of the metal substrate 261 (inner empty wall 261s and surroundings of the hole 261n) may be heated with a pair of the heating units 262 and 263, as shown in the cross sectional view of FIG. 11.

Further, in Embodiment 7 showing the coating apparatus having a gutter component, only a coating apparatus having an inner cylinder 291 covered by a cap having a hole 291d is described, but coating apparatuses having an entirely open top end without a cap and having an upper end completely covered with a cap may also be used. In Embodiment 8, the coating apparatus comprising the inner cylinder 296 having no cap at the upper end is described, but may be replaced with that having a cap completely covering the top end thereof In addition, the inner cylinder may have two or more gutter components.

Although only the coating apparatus having one inner cylinder inside inner container 212 is only described in Embodiments 6 to 8, the coating apparatus may have two or more inner cylinders.

In Embodiments 9 and 10, a spur gearwheel is used as the conveying means, but the conveying means are not limited to the gearwheel but include a disk having an irregular circumferential surface and the like.

In Embodiment 10, a coating apparatus having two guides 321 is described, but may be replaced with that having only one guide 321, depending on the masking region of the substrate.

In addition, sealing components in Embodiments 11 to 15 are all spherical, but the sealing components are not limited to the shape and include those that are conical, conical trapezoidal, and in an egg-like shape.

Although only tubular substrates are described in Embodiments 11 to 15, a bar of substrate may also be used. If one end surface of the bar of substrate is not desired to be masked, a plate-like covering component, for example, may be used replacing the spherical sealing component described above. The bar of substrate can be coated only on the circumferential surface by covering one end surface with the plate-like covering component. Alternatively, the plate-like covering component may be formed in a desired shape. By using such a covering component, it becomes possible to leave a non-masking region in a desired shape on the substrate. The end surface of the bar of substrate is not necessarily flat, and a covering component suitable for the curved surface is preferably selected in such a case. In addition, the covering component may have a hole into which a portion sticking out from the end surface of a bar of substrate fits, so that it can cover part of the circumferential surface of the portion sticking out from the end surface thereof.

In a similar manner to the conventional fluidized bed method wherein electrostatic coating is frequently employed, the electrostatic coating may also be applied to the coating apparatus of the present invention. For example, the coating may be conducted with a combination of a negatively charged powder (fluid) in the dipping container and a positively charged substrate.

1. A coating apparatus for coating a fluid such as a powder, a paste, or the like on a substrate, characterized in that the coating apparatus comprises a fluid circulation system wherein the fluid ascending in a dipping container overflows an overflow edge disposed at the top of the dipping container into an overflow-fluid receiving container and returns from the bottom of the overflow-fluid receiving container into the dipping container, and the dipping container has a depth of 1/3 to 2/3 of the internal diameter thereof.

2. The coating apparatus according to claim 1, wherein the dipping container and the overflow-fluid receiving container are configured respectively to be cylindrical in shape, and the dipping container is disposed inside the overflow-fluid receiving container.

3. The coating apparatus according to claim 1, wherein the fluid has a repose angle of 50 degree or less.

4. The coating apparatus according to claim 1, wherein at least the dipping container is configured to vibrate minutely.

5. The coating apparatus according to claim 1, wherein a screw for conveying the fluid upward from the lower part to the overflow edge thereof is disposed within the dipping container.

6. The coating apparatus according to claim 1, wherein the dipping container includes a narrow discharge component having a narrow discharge opening disposed at the upper part of a cylindrical wall thereof, and the discharge opening is used as a fluid coating component for coating on an arbitrarily selected portion of the surface of the substrate.

7. The coating apparatus according to claim 6, wherein the narrow discharge component having a narrow discharge opening at the upper part thereof is removably connected to an upper part of the cylindrical wall.

8. The coating apparatus according to claim 6, wherein the narrow discharge component having a narrow discharge opening is disposed but not directly connected to the cylindrical wall.

9. The coating apparatus according to claim 8, wherein the narrow discharge component is supported by the overflow-fluid receiving container.

10. The coating apparatus according to claim 8, wherein the narrow discharge opening is disposed at the top end of the narrow discharge component.

11. The coating apparatus according to claim 8, wherein the narrow discharge opening is disposed in the sidewall of the narrow discharge component.

12. The coating apparatus according to claim 8, wherein the narrow discharge component includes an opening in the side wall thereof to which a gutter component is connected, and the top open part of the gutter component is used as a narrow discharge opening.

13. The coating apparatus according to claim 6, where a plurality of narrow discharge openings are provided.

14. The coating apparatus according to claim 13, wherein the plurality of narrow discharge openings are disposed in different heights.

15. The coating apparatus according to claim 1, wherein the coating apparatus includes conveying means for pushing the fluid further upward in the dipping container and conveying the same to an outer predetermined side surface of a substrate; the conveying means has a rotatable disk with a predetermined thickness; the rotational shaft of the disk is disposed in the direction completely or approximately parallel to the top surface of the fluid contained in the dipping container; and part of the disk is inserted in the fluid at the upper part of the dipping container.

16. The coating apparatus according to claim 15, wherein the disk is a gearwheel.

17. The coating apparatus according to claim 15, wherein one or two guide plates for conveying the fluid are disposed respectively along one or two sides of the disk.

18. The coating apparatus according to claim 1, wherein the coating apparatus is adapted for coating the fluid on an outer surface of a substrate having an opening inside; the coating apparatus includes sealing means for sealing the opening; the sealing means for sealing the opening has a sealing component for sealing the opening of the substrate at a position above the dipping container; and the outer surface of the substrate is inserted into the fluid with the sealing component being pressed to the opening of the substrate during the insertion into the fluid.

19. The coating apparatus according to claim 18, wherein the sealing means for sealing the opening includes the sealing component at an end or at a position close to the end of a rod disposed above the fluid in the dipping container in the direction completely or approximately parallel to the top surface of the fluid.

20. The coating apparatus according to claim 18, wherein the sealing means for sealing the opening includes the sealing component at a top end of a spring component disposed inside the dipping container.

21. The coating apparatus according to claim 18, wherein the sealing means for sealing the opening includes two or more sealing components.

22. The coating apparatus according to claim 1, wherein the coating apparatus includes covering means having a covering component for covering at least a part of the substrate disposed at a position above the dipping container; and the part of the substrate is inserted into the fluid with the sealing component being pressed to an end surface of the substrate during the insertion into the fluid.

23. The coating apparatus according to claim 22, wherein the covering means includes the covering component at the end or at a position close to the end of a rod disposed above the top surface of the fluid in the dipping container in a direction approximately parallel to the top surface of the fluid.

24. The coating apparatus according to claim 22, wherein the covering means includes the covering component attached to a top end of a spring component disposed inside the dipping container.

25. The coating apparatus according to claim 22, wherein the covering means includes two or more covering components.
